(19) United States
(12) Patent Application Publication
(10) Pub. No.: US 2020/0372763 A1
(43) Pub. Date: Nov. 26, 2020

(54) INTERACTIVE SYSTEM FOR ENABLING HYBRID FANTASY-STYLE PARI-MUTUEL WAGERING OVER NETWORK INTERFACES

(71) Applicant: StableDuel LLC, Lexington, KY (US)

(72) Inventors: August Greiner, JR., Kew Gardens, NY (US); Christopher Brothers, Kew Gardens, NY (US); Peter Zacchea, Kew Gardens, NY (US)

(21) Appl. No.: 16/880,872

(22) Filed: May 21, 2020

Related U.S. Application Data
(60) Provisional application No. 62/851,490, filed on May 22, 2019.

(51) Int. Cl. G07F 17/32; G06Q 50/34

(52) U.S. Cl. CPC G07F 17/3288; G06Q 50/34

(57) ABSTRACT

Systems and techniques are described to provide an application through which users can participate in online virtual competitions through a network interface. This can include, for example, contests tied to pari-mutuel wagering. The virtual contests can combine aspects of fantasy-styled sports and pari-mutuel wagering to provide a hybrid contest structure that is distinct from those provided by other fantasy sports systems and other pari-mutuel wagering systems. As described below, these distinctions can enable the systems to provide contests with greater flexibility, competitiveness, and fairness. Additionally, data associated with the virtual contests received through the application can be processed using pattern recognition techniques to provide functionalities that are not performable by many other contest systems.

### CROSS-REFERENCE TO RELATED APPLICATIONS

This application claims priority to U.S. Application Ser. No. 62/851,490, filed on May 22, 2019, which is incorporated by reference in its entirety.

### FIELD

This specification relates to generally to electronic gaming systems. More specifically, the present technology may be applied to information systems for sports contests.

### BACKGROUND

In some fantasy sports games, users compete against others by building a team of professional athletes from a particular league or competition while remaining under a salary cap, and earn points based on the actual statistical performance of the athletes in real-world competitions. Daily fantasy sports are an accelerated variant of traditional fantasy sports that are conducted over short-term periods, such as a week or single day of competition. Daily fantasy sports are typically structured in the form of paid competitions typically referred to as a “contest” where winners receive a share of a predetermined pot funded by their entry fees. A portion of entry fee payments go to the provider as rake revenue.

Pari-mutuel wagering refers to a betting contest in which activity of a particular type are placed together in a pool. In such contests, payoff odds are calculated by sharing the pool among all winning bets with certain deductions (e.g., taxes, “house-take” fees, “vigorish” fees). Pari-mutuel wagering can be used in gambling on different types of sporting events, such as horse racing, greyhound racing, jai alai, and other sporting events of relatively short duration in which participants finish in a ranked order. Pari-mutuel wagering differs from fixed-odds betting in that the final payout is not determined until the pool is closed. In fixed odds betting, the payout is agreed at the time the bet is sold. Pari-mutuel gambling is frequently state-regulated, and offered in many places where gambling is otherwise illegal. Pari-mutuel gambling is often also offered at “off track” facilities, where participants may bet on the events without actually being present to observe them in person.

### SUMMARY

In general, the present specification describes systems and techniques that provide an application through which users can participate in online virtual competitions through a network interface. This may include, for example, contests tied to pari-mutuel wagering. The virtual contests disclosed herein have a hybrid contest structure that combines aspects of fantasy-styled sports and pari-mutuel wagering that is distinct from those provided by other fantasy sports systems and other pari-mutuel wagering systems. As described below, these distinctions can enable the systems to provide contests with greater flexibility, competitiveness, and fairness. Additionally, data associated with the virtual contests received through the application can be processed using pattern recognition techniques to provide functionalities that are not performable by many other contest systems.

One example of a virtual contest with a hybrid contest structure is a fantasy-style horse racing contest. In this type of contest, the system uses the betting odds (e.g., morning line odds), which is assigned to a horse for predicting the probability that the horse will win a horse race, to compute a salary value for the horse. A user can then use the salary values of horses to select horses to include in a “stable” (e.g., a selection of six horses that the user wagers as finishing favorably in a horse race). Horse selections for the stable are limited by a predetermined salary cap so that users are prevented from only selecting the horses with the strongest betting odds. The stables are then used as wagers for horse races so that race outcomes are compared with stables to determine contest winners. In this way, the fantasy-style horse racing contest provides an new contest structure that differs entirely from traditional fantasy-style sports and pari-mutuel wagering contests. In particular, the fantasy-style horse racing contest combines the assignment of salary values for selectable entities and limitations on selections based on a salary cap of fantasy-style sports with the use of betting odds to allow users to make bets on race outcomes, as is the case for certain wagering contests.

Many electronic gaming systems, such as fantasy sports system, enable users to wager on the outcome of sporting events through, for example, fantasy sports leagues. Fantasy sporting is typically a contest in which participants act as owners to build a sports team and then compete against other fantasy owners based on statistics generated from real-life players, teams, and sporting events. For many of these fantasy “leagues,” teams remain static, or mostly static, for an entire sporting season.

Fantasy sports systems have enabled a new form of sports participation. For example, online fantasy sports provide an online game of skill where participants assemble imaginary or virtual teams of real players of a professional sport. These teams compete based on the statistical performance of those participants' players in actual games. This performance is converted into points that are compiled and totaled according to a roster selected by each fantasy team's manager. These point systems can be manually calculated by an entity (e.g., a league commissioner) that coordinates and manages the overall league. Alternatively, points can be compiled and calculated using computers tracking actual results of the professional sport. In fantasy sports, team owners draft, trade and cut (drop) players, analogously to real sports.

The application enables users to interact and participate within a software framework that combines aspects of fantasy sports and pari-mutuel wagering. For example, the users can use the application to receive real-time data feeds related to an online virtual contest, place bets on the sporting event through a network interface, and interact with other users that participate in the game. In this way, the application enables users to remotely participate in a pari-mutuel wagering contest that has aspects of fantasy sports in that a maximum salary cap and individual salary values for selections are used to limit the bets the users places through the application. This improves over other gaming systems that would otherwise require the user to be physical present at the sporting event or a designated location (e.g., off-track-betting (OTB) at a sanctioned location). Other technical advantages provided by the systems and techniques are described below.

In one example, the hybrid virtual contest represents a fantasy-style pari-mutuel virtual contest. In this example, users select a number of participating horses (e.g., six horses) of a horse racing event to be included in a stable. Race outcome data is used to compute a score for the user's stable that represent the user's contest performance. For example, if all of the horses selected by the user finish in first or second place in the horse races, then the score computed for the user is higher than the score computed for another user whose horse selections all finish in last place. Horse selection for a stable is limited by a maximum salary cap value specified for all users. Each horse that is scheduled to participate in a horse racing event is assigned a salary value based on pre-event race statistics. For example, a horse that has greater odds to win a particular race (based on prior performance) will have a higher salary value relative to another horse that has lower odds to win the particular race. Scores computed for users can be used to determine winners of the horse race betting contest for awarding the contest prize, distribute rewards points that can be used by users, among others discussed in more detail below.

The systems described herein can be configured to address challenges that are often involved in administering virtual contests. For example, in horse race betting, an electronic system that administers user pools can be manipulated by fraudulent actors that provide stable selections after a horse race event has started, thereby providing a competitive advantage relative to users that placed stable selections before the horse race event started (i.e., without knowledge of the outcome of the races that have already occurred). Without security measures in place, some users can manipulate electronic or paper data relating to stable selections, which then compromises the integrity of a horse betting contest. The systems can address this and other problems by, for example, incorporating know-your-customer (KYC) procedures during an enrollment process that is a prerequisite to participate in the virtual contests provided through the application. The application can also incorporate the use of payment processors to validate identities in association with transactions performed through the system. This ensures that virtual activity data collected through an application is traceable to a known user identity, improving user accountability relative to other horse race betting systems that do not collect or track such identity data.

As another example, in horse race betting, the system can employ time-based stable selections that restrict users from performing certain actions, such as entering user pools, placing delayed stable selections, and/or using insider information to gain an unfair advantage in a horse race betting contest. To accomplish this, the system configures a user application to manage and track historical activity to improve the likelihood of identifying suspicious user activity. This monitoring aspect is often challenging with other off-track-betting systems, where user betting data is not captured or monitored other than for single games.

Moreover, the systems described herein can be configured to provide certain features that provide technical advantages over other electronic game systems (e.g., pari-mutuel wagering systems, fantasy sports systems). For example, customizable user pools can be used to classify users based on skill level to provide users with a more even playing field when participating in a game. The systems can use the user pools to classify users into designated clusters so that professionally-trained users are prevented from entering into user pools that only include users with an amateur skill level.

The systems described herein can also be configured to provide features that are supplement and/or improve upon existing functionality imparted by many electronic gaming systems. In this way, the systems described herein provide improvements to computer technology as it relates to enabling user activity over a network medium. In some implementations, the systems can incorporate a content streaming session associated with user activity through an application. For example, a system can provide information feeds (e.g., live or recorded video feeds, article feeds, notifications, live chat room) through the application. The application can provide notifications associated with a game that a user is actively participating without requiring the user to constantly check the application. As another example, the system can provide a spectatorship platform where external viewers (e.g., YouTube subscribers) access video and/or data feeds of participant activity during a contest provided through an electronic pari-mutuel wagering system.

In some implementations, the systems can use techniques to improve user engagement through an application based on activity data collected for users through the application. For example, user activity through the application can be monitored to track a user's historical activity over multiple game sessions. The metrics can then be processed using pattern recognition techniques to identify, for instance, a user's play style, reoccurring mistakes, frequent betting tactics, among others. This information can be aggregated to provide users with instructional tools to develop his/her better performance. For instance, users can be provided with tutorials and/or recommendations based on associated metrics, which thereby improves user engagement through the application and the likelihood that the user will continue to use the application to participate in subsequent games. In some instances, a recommendation engine can also be used to assist users as they participate in certain betting games.

The systems described herein can also customize contest definitions and associated prize distribution schemes in a manner that is often not achievable using many other electronic gaming systems. This capability enables the generation of contest definitions that vary from many traditional pari-mutuel wagering schemes. For example, a contest can be designed to attribute negative and positive points to users during a game based on outcomes of certain bets (e.g., the number of lengths between horses in a horse race). These new types of content definitions not only adjust the way a user participates in a game when placing bets, but can sometimes result in varying prize distribution scheme. For example, instead of being distributed cash for winning a pool, a user can be distributed with a set of points so that all users can be provided with some type of reward (other than only the winner receiving a payout). Points-based prize distribution schemes can be combined with rewards programs to enable users to use earnings to purchase associated content.

In one general aspect, a fantasy-style horse race wagering system can enable to a user to field, over a network interface, a virtual stable of at least a first horse appearing in a first race and a second horse appearing in a second race in a schedule of races. The system includes one or more computers; and at least one non-transitory computer-readable medium storing instructions thereon that, when accessible by the one or more computers, cause the one or more computers to perform operations. The operations include providing, over the network interface, an application that (i) permits a user to participate in the fantasy-style horse race wagering system associated with a set of participating horses in a horse racing event by identifying the user to field the virtual stable, and (ii) restricts the user from participating in the fantasy-style horse race wagering system after the horse racing event has started. The fantasy-style horse race wagering system employs a scoring system different from an odds-payoff system associated with a specified race in the schedule of races. The operations include obtaining, from a computing device of the user and over the network interface, data indicating the virtual stable selected by the user; obtaining race result data for each participating horse included in the set of participating horses in real time during the horse racing event; computing, based on the race result data, performance metrics for the virtual stable; computing a performance score for the virtual stable based on the race result data and the performance metrics; and providing, through the application, the performance score for output.

One or more implementations can include the following optional features. In some implementations, the operations further include generating rule data for the fantasy-style horse race wagering system. The rule data specifies: a pre-race salary value for each participating horse included in the set of participating horses based on pre-event statistics associated with the horse racing event; a number of horses for selection by a user to include in a stable, and a maximum salary cap value for the stable.

In some implementations, the virtual stable includes (i) a subset of participating horses selected by the user from among the set of participating horses, and (ii) an aggregate salary cap value of the virtual stable based on the pre-race salary values of the subset of participating horses.

In some implementations, the operations further includes: determining whether the aggregate salary cap value of the virtual stable satisfies the maximum salary cap value specified by the rule data; and determining whether the virtual stable satisfies the rule data based on determining whether the aggregate salary cap value of the virtual stable satisfies the maximum salary cap value specified by the rule data.

In some implementations, the pre-event statistics include respective pre-race odds that each participating horse included in the set of participating horses will win the horse racing event.

In some implementations, generating the rule data for the fantasy-style horse race wagering system includes determining the pre-race salary value for each participating horse included in the set of participating horses based on the respective pre-race odds that each participating horse included in the set of participating horses will win the horse racing event.

In some implementations, computing the performance score for the virtual stable includes: computing, for each participating horse included in the subset of participating horses, a horse performance score representing a performance of a participating horse in the horse racing event; and computing the performance score for the virtual stable by combining the horse performance scores computed for the subset of participating horses.

In some implementations, the race result data indicates a number of lengths between sequential participating horses completing the horse racing event; and the performance score for the virtual stable is computed based at least on the number of lengths between sequential participating horses completing the horse racing event.

In some implementations, the operations further include generating data indicating multiple user pools for the fantasy-style horse race wagering system. The multiple user pools are generated based at least on respective skill levels of a set of users associated with the fantasy-style horse race wagering system. Additionally, each user pool included within the multiple user pools includes users classified as having a different skill level associated with the fantasy-style horse race wagering system.

In some implementations, the multiple user pools are generated based on account data indicating an age associated with a user account.

In some implementations, the multiple user pools include a first user pool. The first user pool includes (i) a given subset of users that are identified as being associated with social network data and (ii) one or more additional users. The one or more additional users are not associated with the social network data and are classified as being relevant to the given subset of users based on account data other than the social network data. In another general aspect, a pari-mutuel wagering system can enable a user to field, over a network interface, a virtual record. The pari-mutuel wagering system includes one or more computers; and at least one non-transitory computer-readable medium storing instructions thereon that, when accessible by the one or more computers, cause the one or more computers to perform operations. The operations include providing, over the network interface, an application that (i) permits a set of users to participate in the pari-mutuel wagering system for a sporting event and (ii) restricts the users from participating in the pari-mutuel wagering system after the sporting event has started; and generating data indicating multiple user pools for the pari-mutuel wagering system through the application. The multiple user pools are generated based at least on respective skill levels of the set of users associated with the pari-mutuel wagering system. Additionally, each user pool included within the multiple user pools includes users classified as having a different skill level associated with the pari-mutuel wagering system.

The operations further include obtaining, from computing devices of the set of users and over the network interface, the virtual record indicating selections representing pari-mutuel wagers placed by the set of users; obtaining progression data for the sporting event in real time after the sporting event has started; computing, for each of the multiple user pools and based on the progression data, performance metrics for the pari-mutuel wagers placed by the set of users; computing, for each user included in the set of users, a performance score based on (i) the virtual record indicating selections representing the pari-mutuel wagers placed by the set of users, (ii) performance metrics for the pari-mutuel wagers placed by the set of users, and (iii) a user pool to which a user is classified; and providing, through the application, the performance scores computed for the set of users for output.

One or more implementations can include the following optional features. In some implementations, the sporting event associated with a set of participating athletes of the sporting event. The operations further include: obtaining pre-event statistics associated with the sporting event, and generating rule data for the pari-mutuel wagers based on the pre-event statistics. Additionally, the rule data specifies: a pre-event salary value for each participating athlete included in the set of participating athletes based on pre-event statistics associated with the sporting event, a number of athletes for selection by a user to include in a fantasy group, and a maximum salary cap value for the fantasy group.

In some implementations, each selection representing the pari-mutuel wagers placed by the set of users includes (i) a particular subset of participating athletes selected by a user from among the set of participating athletes, and (ii) an aggregate salary cap value of a particular fantasy group based on the pre-event salary values of the particular subset of participating athletes.

In some implementations, the operations further include: determining whether the aggregate salary cap value of the particular fantasy group satisfies the maximum salary cap value specified by the rule data; and determining whether the particular fantasy group satisfies the rule data based on determining whether the aggregate salary cap value of the particular fantasy group satisfies the maximum salary cap value specified by the rule data.

The details of one or more implementations are set forth in the accompanying drawings and the description below. Other potential features and advantages will become apparent from the description, the drawings, and the claims.

### BRIEF DESCRIPTION OF THE DRAWINGS

FIG. 1A illustrates an example of a hybrid virtual contest that allows users to participate in a fantasy-style horse race contest.

FIG. 1B illustrates an example of a process architecture for an exemplary embodiment of the disclosed subject matter.

FIG. 2 illustrates an example of a computer processing system within which the process of the present disclosure may operate.

FIG. 3 illustrates an example of a process flow according to one embodiment of the disclosed subject matter.

FIG. 4 illustrates an example of a chart of points awarded by the presently disclosed subject matter according to the finishing position of horses in a given race;

FIG. 5 illustrates an example of a technique for adjusting scores derived from the finishing position points according to horse finishing margins.

FIG. 6 illustrates examples the scoring brackets shown in FIGS. 4 and 5.

FIG. 6A illustrates an example of a data sheet that can be used with a fantasy-styled horse racing gam.

FIG. 7 illustrates an example of a salary conversion table for converting odds of horses to salaries for a given race.

FIG. 8 illustrates an example of a scoring methodology consistent with the teachings of the present disclosure.

FIG. 9 illustrates examples of odds for horses scheduled to run on a particular race day.

FIG. 10 illustrates examples of salaries for horses shown in FIG. 9 as a function of their respective odds.

FIGS. 11-20 illustrate an example of a stable selection process that incorporates the processes, odds, and salaries shown in FIGS. 7-10.

FIGS. 21-30 illustrate examples of techniques for calculating points for a participant stable.

FIG. 31 illustrates an example of a process for providing an application that enables horse race betting through a network interface.

FIG. 32 illustrates an example of a process for providing an application that enables pari-mutuel wagering through a network interface.

In the drawings, like reference numbers represent corresponding parts throughout.

### DETAILED DESCRIPTION

In general, this specification describes systems and techniques that enable users to participate in skill-based virtual contests through a software-based application. The systems can be configured to provide various types of improvements in administering contests over a network interface. For example, activity data collected and monitored through the application can be processed using pattern recognition techniques to improve providing instructional tools and/or recommendations to a user's present skills. Users can use these features to improve their skills, and thereby improve user engagement through the application. As another example, the application can generate custom user pools that classify users based on skill level to improve the competitiveness of any competition hosted through the application. In some other examples, the application is configured to implement security and/or anti-circumvention protocols to improve the detection of suspicious virtual activity and/or reduce the likelihood that the fairness of competitions are compromised due to fraudulent activity. Other advantages provided by the systems and techniques described herein will become apparent in the descriptions below.

### A. Overview

a. Fantasy-Style Sports

A new form of sports participation, fantasy sports, has emerged with great success. Online fantasy sports are a multibillion-dollar industry. A fantasy sport is a type of online game of skill where participants assemble imaginary or virtual teams of real players of a professional sport. These teams compete based on the statistical performance of those participants' players in actual games. This performance is converted into points that are compiled and totaled according to a roster selected by each fantasy team's manager. These point systems can be simple enough to be manually calculated by a “league commissioner” who coordinates and manages the overall league, or points can be compiled and calculated using computers tracking actual results of the professional sport. In fantasy sports, team owners draft, trade and cut (drop) players, analogously to real sports.

Presently, because of high levels of state and federal legal regulation, fantasy sports have failed to grow in sports relying on a pari-mutuel wagering business model as the principal way for participants to engage in the professional sport.

b. Pari-Mutuel Wagering

There have been various attempts by pari-mutuel venues to entice individuals who are attracted to simple wagering activities or the potential for a larger payout. For example, random wagers, sometimes referred to as “quick picks”, have been offered at pari-mutuel venues to satisfy patrons favoring simple wagers. However, those individuals may feel disadvantaged by the fact that other bettors are actively handicapping their wagers and, therefore, may have a better chance at winning a portion of the wagering pool.

In addition to the fact that no known fantasy horse racing game provides the ability to engage in pari-mutuel wagering, there is no known horse racing game that considers both the finishing position the horses in a race, as well as the position of the horse relative to the other horses at the finish. Accordingly, a need exists for a fantasy-styled, pari-mutuel wagering contest.

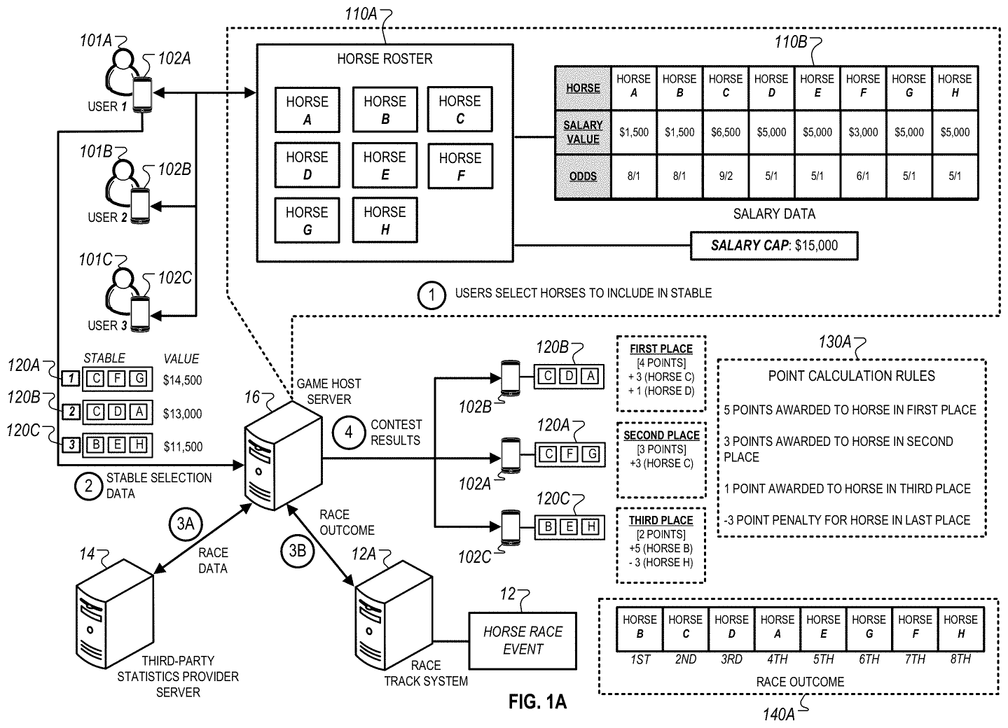

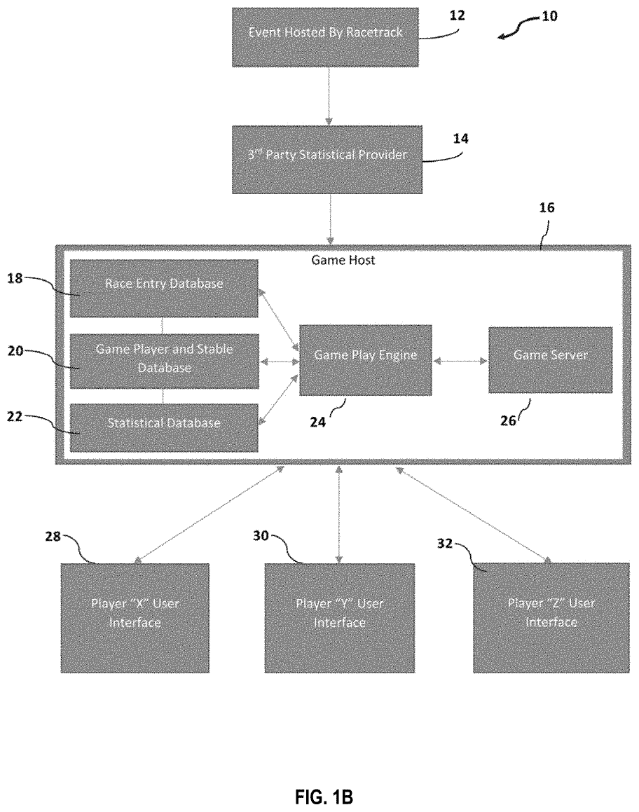

FIG. 1A illustrates an example of a hybrid virtual contest that allows users to participate in a fantasy-style pari-mutuel wagering for a horse race. The virtual contest shown in FIG. 1A allows users to select horses from a horse roster 110A to include in a stable. In this example, the horse roster 110A includes eight horses (e.g., “Horses A-H”) that are scheduled to participate in a horse racing event 12. Each stable includes three horse selections.

Each horse in the horse roster 110A is assigned a salary value based on the odds of that horse winning the horse race. The odds can be, for example, morning line odds that are designated by a morning line maker to predict how users will wager on a particular race. The odds can be based on past performances of the horses and used to reflect which horses the majority of racing fans will wager the most. For example, “Horse A” is assigned a salary value of “$1,500” based on this horse being assigned 8/1 betting odds (i.e., there is a one in eight chance that “Horse A” will win the horse race, or 12.5% chance of winning). In contrast, “Horse C” is assigned a salary value of “$6,500” based on this horse being assigned 9/2 betting odds (i.e., there is a two in nine chance that “Horse C” will win the horse race, or approximately 22% chance of winning). In this example, “Horse A” is assigned a higher salary value than “Horse C” since “Horse A” has higher betting odds of winning the horse race.

A user's selections for a stable are limited by a salary cap representing a maximum available salary for stable selections. The salary value of the stable, in this example, is computed based on adding the individual salary values of three horses that the user selects to include in a stable. For a selection for the stable to be valid, the salary value of the stable must be less than or equal to the salary cap. For example, a stable with a salary value of $14,000 or $15,000 is valid. However, a stable with a salary value of $16,000 is invalid since the salary value of the stable exceeds the salary cap. Since salary values of individual horses is tied to respective betting odds, the salary cap prevents a user from only selecting horses having the highest betting odds of winning a race. Rather, similar to fantasy-style sports, a user is forced to make selections within a limited salary cap using his/her assessment on probabilistic outcomes.

Referring now to the example depicted in FIG. 1A, three users 101A, 101B, and 101C participate in the hybrid virtual contest through user devices 102A, 102B, and 102C, respectively. In some instances, the users 101A-C access the hybrid virtual contest through an application, while in other instances, the users 101A-C access the hybrid virtual contest through a webpage presented on a corresponding user device. Users 101-C must make stable selections within a salary cap of $15,000.

As shown in FIG. 1A, execution of the hybrid virtual contest proceeds in a set of steps. At step (1), users 101A-C select horses from a horse roster 110A to include in their stables. The selections are based on salary data 110B and limited by the salary cap of $15,000. For example, a stable with “Horse C,” “Horse G,” and “Horse H” would be invalid since the total salary value of this stable would be $16,500, which exceeds the salary cap. As discussed above, salary data 110B includes a salary value for each horse based on betting odds assigned to a horse. The odds specified in the salary data 110B are morning line odds determined by a morning line maker of a race course.

In some implementations, the odds can represent other types of betting odds, such as fractional betting odds, decimal betting odds, and moneyline odds. The odds can also be generated based on automated processing of historical race performance data of horses included in the horse roster 110A. For example, the odds can represent a predicted likelihood of a horse winning an upcoming race based on win/loss performance of the horse in previously completed races. In some instances, the odds can further reflect a jockey that is participating in a horse race. In such instances, the odds specified by the salary data 110B can be based on horse odds, jockey odds, or a combination of both.

At step (2), the game host server 16 receives stable selection data including stables 120A, 120B, 120C from the user devices 102A, 102B, and 102C, respectively. Each stable selection data identifies horses that were selected by a corresponding user from the horse roster 110A. As shown, stable 120A indicates that the user 101A selected Horses C, F, and G for his/her stable, stable 120B indicates that the user 101B selected Horses C, D, and A for his/her stable, and stable 120C identifies that the user 101C selected Horses B, E, and H for his/her stable. The stable selection data also indicates the salary value of the corresponding stable. For example, the salary value of the stable within stable 120A is $14,500, which is the total of individual salary values of Horses C, F, and G (i.e., a sum of $6,500, $3,000, $5,000). As another example, the salary value of the stable within stable 120B is $13,000, which is the total of individual salary values of Horses C, D, and A (i.e., a sum of $6,500, $5,000, $1,500).

At step (3A), the game host server 16 obtains race data from a third-party statistics provider server 14. The race data can be obtained during or after a horse race has started. For example, race data obtained prior to the horse race can be displayed to the users 101A-C during the stable selection stage to allow users to access, for example, horse racing statistics. As examples, the race data can specify races that have taken place during the horse racing event, the winning horse, and statistics associated with the races that have occurred (e.g., a number of lengths between horses that complete a particular race).

At step (3B), the game host server 16 obtains race outcome information 140A from a race track system 12A. In the example depicted, the race outcome information 140A identifies the order of horses completing the horse race event 12. As shown, Horse B finished first, followed by Horses C, D, A, E, G, and F, with Horse H finishing either (or last place). Though the example shown in FIG. 1A depicts the outcomes of a single race for simplicity, the system can be used to enable virtual contests with multiple races occurring within a single horse race event (e.g., three horse races on a single day), as described throughout this specification.

At step (4), the game host server 16 generates contest results based at on the race outcome data and the race data. In the example depicted, each user is awarded points based on point calculation rules 130A. The points awarded to each user are then summed to identify a contest winner. In the example, the contest winner is a user that has been awarded the greatest number of points.

As shown in FIG. 1A, points are awarded based on conditions specified by the point calculation rules 130A being met by a user's stable selections in relation to the race outcome information 140A. For example, because stable 120B includes horses that finished in second and third place (Horses C and D, respectively), the stable 120B satisfies two rules within the point calculation rules 130A—(1) “3 points awarded to horse in second place” and (2) “one point awarded to horse in second place.” Based on this, user 101B is awarded a total of four points. As another example, because stable 120A includes a horse that finished in second place (Horse C), the stable 120A only satisfies one rule within the point calculation rules 130A—“3 points awarded to horse in second place” and (2) “one point awarded to horse in second place.” Based on this, user 101A is awarded a total of three points. Finally, because stable 120C includes a horse that finished in first place (Horse B) and a horse that finished in last place (Horse H), the stable 120C satisfies two rules within the point calculation rules 130A—(1) “5 points awarded to horse in first place” and (2) “three point penalty for horse in last place.” Based on this, user 101A is awarded a total of two points. User 101B is designated the contest winner with a total of four points, followed by user 101A in second place with three points, and user 101C in third place with two points.

As discussed throughout, the hybrid contest structure depicted in FIG. 1A differs from traditional fantasy-style sports and pari-mutuel wagering contests in that it combines aspects both. For example, the hybrid contest structure combines the assignment of salary values for selectable entities and limitations on selections based on a salary cap of fantasy-style sports with the use of betting odds to allow users to make bets on race outcomes, as is the case for wagering contests. Specifically, traditional fantasy-style sports typically do not involve wagering based on assigned betting odds, as shown in the example depicted in FIG. 1A. Additionally, while traditional horse race wagering contests allow users to select horse picks and have prize distribution schemes based on race outcomes, they typically do not assign salary values to individual horses, or use points as a prize distribution scheme. In the example depicted in FIG. 1A, points can be applied both as a reward (e.g., points awarded to favorable race outcomes) as well as a penalty (e.g., point penalty for unfavorable race outcomes), thereby increasing the dimensions by which users can compete with one another. As discussed in greater detail below, the application of points as a prize distribution scheme can also be tied into commercial platforms through which users can use awarded points as virtual currencies.

FIG. 1B illustrates a process architecture for an example of a fantasy-styled, horse racing game 10. Racing game 10 contemplates an event 12 a racetrack may host. Event 12 represents the accumulation of all races that an actual racetrack will provide on a given day and correspond to information processed by the fantasy-styled horse racing game 10. Entries, odds, historical information, and other data relating to individual horses participating in event 12 derive from data presented by a third-party statistical provider 14. Game host 16 provides a race entry database 18 in association with a game participant and stable database 20, which further associates with a statistical database 22. Race entry database 18, game participant and stable database 20, and statistical database 22 further communicate with game play engine 24. In operation, game play engine communicates with game server 26 for providing the computational power for game host 16. Participants “X,” “Y,” and “Z” access game host 10 via participants to accessing game host play fantasy-styled horse racing game 10 through game host 16,

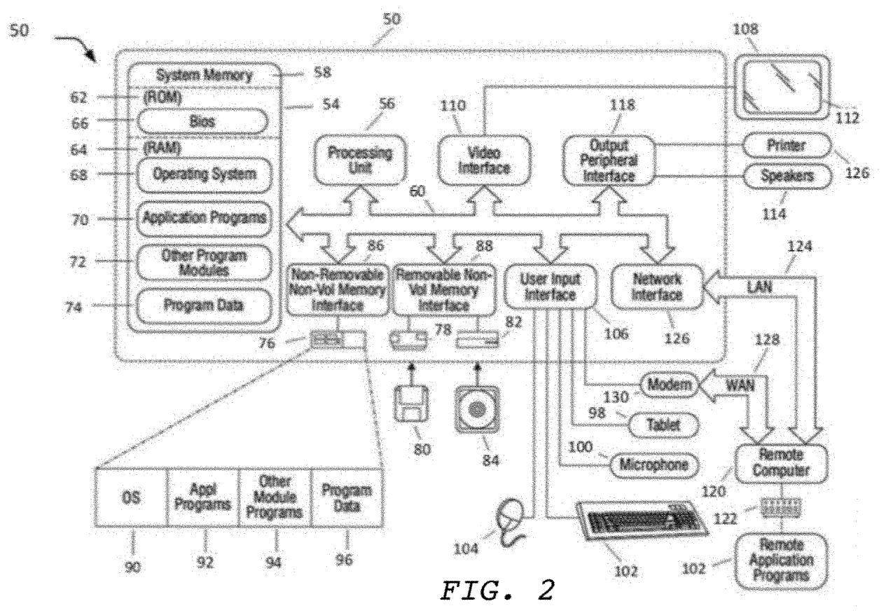

FIG. 2 illustrates a computer processing system within which the process of the present disclosure may operate. The data capture, analysis, and use of the method and system of the present disclosure require the use of a computing system associated with a three-dimensional camera system. Thus, with reference to FIG. 2, an exemplary system within computing environment 50 for implementing the disclosure includes a general purpose computing device in the form of computing system 52, commercially available from, for example, Intel, IBM, AMD, Apple, Motorola, Cyrix, etc. Components of computing system 54 may include, but are not limited to, processing unit 56, system memory 58, and system bus 60 that couples various system components including system memory 58 to processing unit 56. System bus 60 may be any of several types of bus structures including a memory bus or memory controller, a peripheral bus, or a local bus using any of a variety of bus architectures.

Computing system 52 typically includes a variety of computer readable media. Computer readable media can be any available media that can be accessed by computing system 52 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 52.

System memory 58 includes computer storage media in the form of volatile and/or nonvolatile memory such as read only memory (ROM) 62 and random access memory (RAM) 64. A basic input/output system (BIOS) 66, containing the basic routines that help to transfer information between elements within computing system 52, such as during start-up, is typically stored in ROM 62. RAM 64 typically contains data and/or program modules that are immediately accessible to and/or presently being operated on by processing unit 56. By way of example, and not limitation, operating system 68, application programs 70, other program modules 72, and program data 74 are shown.

Computing system 52 may also include other removable/non-removable, volatile/nonvolatile computer storage media. By way of example only, hard disk drive 76 that reads from or writes to non-removable, nonvolatile magnetic media, a magnetic disk drive 78 that reads from or writes to removable, nonvolatile magnetic disk 80, and an optical disk drive 82 that reads from or writes to removable, nonvolatile optical disk 84 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 76 is typically connected to the system bus 60 through a non-removable memory interface such as interface 86, and magnetic disk drive 78 and optical disk drive 82 are typically connected to the system bus 60 by a removable memory interface, such as interface 88.

The drives and their associated computer storage media, discussed above, provide storage of computer readable instructions, data structures, program modules and other data for computing system 52. For example, hard disk drive 76 is illustrated as storing operating system 90, application programs 92, other program modules 94 and program data 96. Note that these components can either be the same as or different from operating system 68, application programs 70, other program modules 72, and program data 74. Operating system 90, application programs 92, other program modules 94, and program data 96 are given different numbers here to illustrate that, at a minimum, they are different copies.

A participant may enter commands and information into the computing system 52 through input devices such as tablet or electronic digitizer 98, microphone 100, keyboard 102, and pointing device 104, commonly referred to as a mouse, trackball, or touch pad. These and other input devices are often connected to the processing unit 56 through a participant input interface 106 that is coupled to the system bus 60, but may be connected by other interface and bus structures, such as a parallel port, game port or a universal serial bus (USB).

Monitor 108 or other type of display device is also connected to the system bus 60 via an interface, such as a video interface 110. Monitor 108 may also be integrated with a touch-screen panel 112 or the like. Note that the monitor and/or touch screen panel can be physically coupled to a housing in which computing system 52 is incorporated, such as, for example, in a tablet-type personal computer or smart phone. In addition, computers such as computing system 52 may also include other peripheral output devices such as speakers 114 and printer 116, which may be connected through an output peripheral interface 118 or the like.

Computing system 52 may operate in a networked environment using logical connections to one or more remote computers, such as a remote computing system 120. The remote computing system 120 may be a personal computer (including, but not limited to, mobile electronic devices), a server, a router, a network PC, a peer device or other common network node, and typically includes many or all of the elements described above relative to computing system 52, although only a memory storage device 122 has been illustrated. The logical connections depicted include a local area network (LAN) 124 connecting through network interface 126 and a wide area network (WAN) 128 connecting via modem 130, but may also include other networks such as, for example, mobile telephone service networks. Such networking environments are commonplace in offices, enterprise-wide computer networks, intranets, mobile networks, and the Internet.

For example, in the present embodiment, computer system 52 may comprise the source machine from which data is being generated/transmitted and the remote computing system 120 may comprise the destination machine. Note however that source and destination machines need not be connected by a network or any other means, but instead, data may be transferred via any media capable of being written by the source platform and read by the destination platform or platforms.

In another example, in the present embodiment, remote computing system 120 may comprise the source machine from which data is being generated/transmitted and computer system 52 may comprise the destination machine.

In a further embodiment, in the present disclosure, computing system 52 may comprise both a source machine from which data is being generated/transmitted and a destination machine and remote computing system 120 may also comprise both a source machine from which data is being generated/transmitted and a destination machine.

Referring to FIG. 2, for the purposes of this disclosure, it will be appreciated that remote computing system 120 may include any suitable term such as, but not limited to “device”, “processor based mobile device”, “mobile device”, “electronic device”, “processor based mobile electronic device”, “mobile electronic device”, “wireless electronic device”, or “location-capable wireless device,” including a smart phone or tablet computer.

The central processor operating pursuant to operating system software such as, but not limited to, Apple IOS®, Google Android® IBM OS/2@, Linux®, UNIX®, Microsoft Windows®, Apple Mac OSX®, and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation, and algorithm generation. The provided functionality may be embodied directly in hardware, in a software module executed by a processor, or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

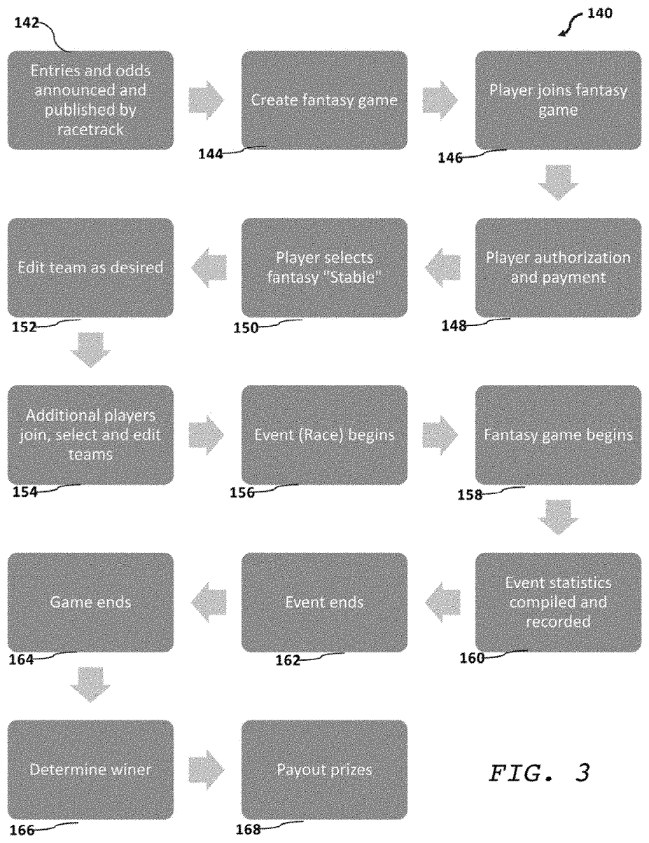

FIG. 3 depicts process flow 140 from a participant's perspective according to one embodiment of the disclosed subject matter. In process flow 140, step 142 represents the action of a racetrack publishing entries and odds to provide corresponding data associated with a daily event 12. In addition, at step 142, process flow includes the actions of acquiring race entries and odds from third party supplier. One such supplier may be Equibase Company LLC; however other such suppliers may provide similar data and information for announcing the entries and odds for a particular event 12.

Fantasy-style horse racing game 10 of the present disclosure converts odds that a given horse receives into salaries for use by participants. Thus, a participant receives from the present method and system, salary values respecting the horsed to be raced in a given contest. Generally, the participant does not see odds for a horse, but only the horse salary. However, another embodiment of the present disclosure may show horse odds without departing from the scope of the inventive subject matter.

At step 144, process flow 140 creates a fantasy horse-racing game. This may include establishing a prize pool, entry fees, horse racing track, the racing date, and other information. A participant may join horse racing game 10, at step 146. Here, the participant receives information about the event from race entry database 18 and, basically, begins interacting with fantasy-styled horse racing game.

Whether a participant has or needs to establish an account is determined, at step 148. A participant may also pay an entry fee, at step 148.

Step 150 permits the participant to select a “stable” of horses, as well as provides an automatic calculation of salary cap balance. Each contest within the disclosed subject matter is a “game” that requires the participant to select a “stable” of a certain number of horses (for a standard “StableDuel” game the number is ten horses). In selecting the horses for a stable, the participant must stay under the “salary cap” limit established for that game. For the present illustrative embodiment of fantasy-styled horse racing game 10, a salary cap could be $50,000. Horses are typically selected from the race card from a single track on a certain day. However, there may be contests that allow the participant to select horses from multiple tracks on a certain day, as well as selecting horses on a specified track over multiple days. For example, in the Breeder's Cup Championship, races occur over a two-day weekend. Such variations clearly fall within the scope of the present inventive subject matter. The salary for each horse will be determined by their morning line odds as may be provided by a track handicapper and published with the track entries.

The participant is not required to select a horse from each race on the card. The participant may select multiple horses from a certain race while selecting none from another. The participant, however, must select the required number of horses to complete their stable.

A participant may edit a stable, as desired, at step 152. Moreover, additional participants may join, select and edit teams, at step 154. At this point, horse racing game 10 closes contest entries at an established time, such as prior to post of first race and lists all for the contest on the horse racing game 10 website associated with game host 16.

The first horse race associated with fantasy-styled horse racing game 10 begins at step 156, followed immediately thereafter by the beginning of horse racing game at step 158. Fantasy-styled horse racing game 10 incorporates Equibase race event statistics representing results from each race at step 160.

At step 160, all other core operations of fantasy-styled horse racing game 10 also occur. So, after the first race occurs, system 10 receives statistics from Equibase all information concerning the actual horse race at the racetrack. This includes the first, second, etc. placing of the horses at finish, as well as the position of the horses in comparison to one another, etc. the numbers of lengths behind the winning horse.

Fantasy-styled horse racing game 10, in response to receiving race statistics, derives point values for each racing horse, as well as point values for each stable competing in the fantasy-styled horse race.

At step 162, the associated horse race event ends, followed by fantasy-styled horse racing game 10 ending at step 164. At step 166, all of the totals compiled throughout the day are totaled to derive a total score. Also at step 166, contest winners based upon final scoring occurs. Then, at step 168 of process flow 140, fantasy-styled horse racing game 10 pays prizes based upon the award schedule previously established at step 144.

To illustrate how the presently disclosed subject matter awards points, FIG. 4 presents point allocation chart 170 for graphically describing how game scoring may occur. Thus, FIG. 4 shows along the ordinate axis the relative finishing position of the horses in an actual race associated with fantasy-styled horse racing game 10. Along the abscissa axis appear points ranging from 0 to 70 points. So, a first place finishing position awards a horse 60 points, a second place finishing position awards 40 points, third place wins 30 points, fourth 20 points, and fifth 10 points. Sixth place and higher win no points.

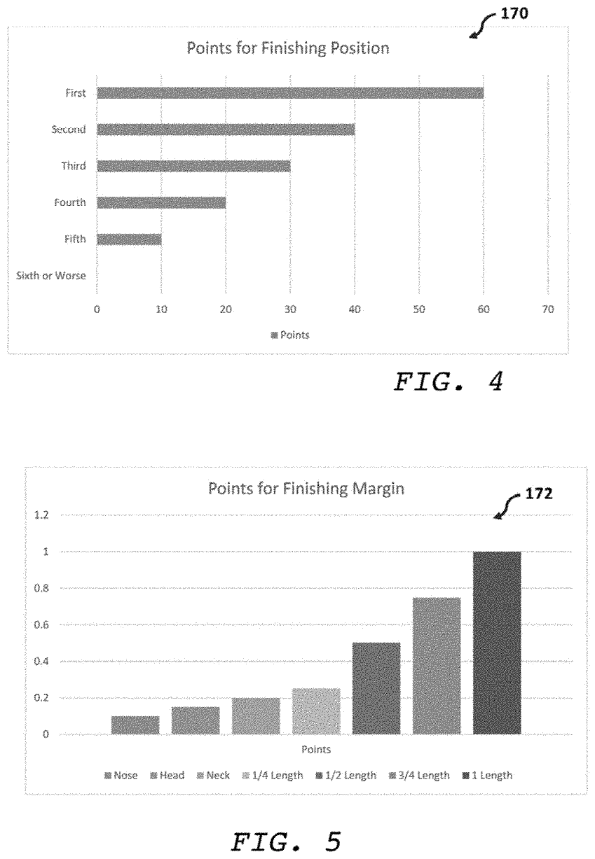

FIG. 5 separately shows chart 172 for illustrating how the present disclosure adjusts scores derived from the finishing position values according. Points will be calculated based on two determining factors; finishing position and margin of victory/defeat. Horses will earn points for their finishing position (first, second, third etc.), as FIG. 4 shows and then will have points added or subtracted from their total based on their margin of victory/defeat. As will be shown below, if the first place horse wins by 2% lengths, for example, 2.5 points are added to his score of 60 points, for a total of 62.5 points. Conversely, if the third place horse lags the winner by 4% lengths, 4.25 points are subtracted from the 30 points earned for the third place finish, to yield a 25.75 point award.

FIG. 6 summarizes the scoring brackets of FIGS. 4 and 5. Thus, the points added for finishing position and added or subtracted for length provide a basis for determining final scores for all horses recorded through fantasy-styled horse racing game 10.

FIG. 6A shows an exemplary data sheet, as may be provided by Equibase Company LLC. Through its website, upgraded mobile platform and mobile applications, Equibase Company LLC offers a comprehensive menu of handicapping products, statistical information and video race replays in support of the North American Thoroughbred racing industry. The company provides statistical profile pages for horses, jockeys, trainers, and owners, as well as Excellence Indicators to provide information on the person or horse's highest achievements.

In illustrating the exemplary races, the present disclosure uses Equibase Charts. The Equibase Charts help illustrate what the presently disclosed fantasy-style horse racing game uses to help with the scoring calculations. In particular, the following description references the “Past Performance Running Line Preview” data of the Equibase Charts to obtain finishing positions and margins of victory and/or defeat for each horse. That is, in the following charts appear the Past Performance Running Line Preview data, appearing in the far right column, to more specifically depict how one may play the disclosed fantasy-styled horse racing game 10.

For the FIG. 6A example of the Equibase Chart for a given thoroughbred horse race, the respective Past Performance Running Line Review data, i.e., segment 177 appears as shown. In the FIG. 6A example, the racehorse, Songbird, shows Fin (Finishing) position of 1, or 1st place with a winning margin of 5 3/4 lengths. In the “Fin” (finish) column, this appears with the number 1 and superscript 5 3/4. Thus, Songbird receives 60 points for winning and 5.75 points for winning by 5 3/4 lengths.

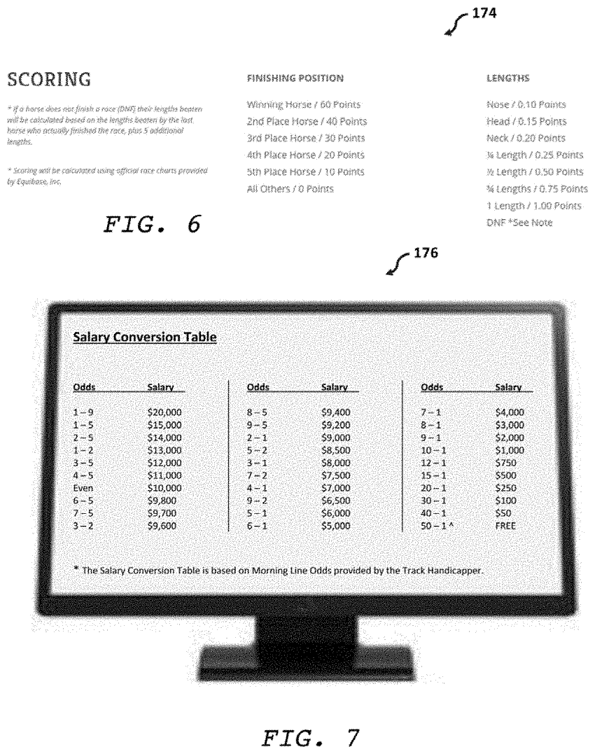

FIG. 7 presents salary conversion table 176 for converting odds of horses to salaries for a given race. Another important aspect of fantasy-styled horse racing game 10 includes associating horse salaries with odds. The odds may be obtained from the morning line odds that a racetrack may publish or distribute on race day. The morning line odds may, for example, be supplied by an official track handicapper. These are based on many factors and do not technically reflect how actual betting will progress. With reference to FIG. 7, salary conversion table 176 relates an individual horse's odds to a particular horse salary. Odds of 1-9 receive a salary of $20,000, 1-5 a salary of $15,000, 2-5 a $14,000 salary, etc.

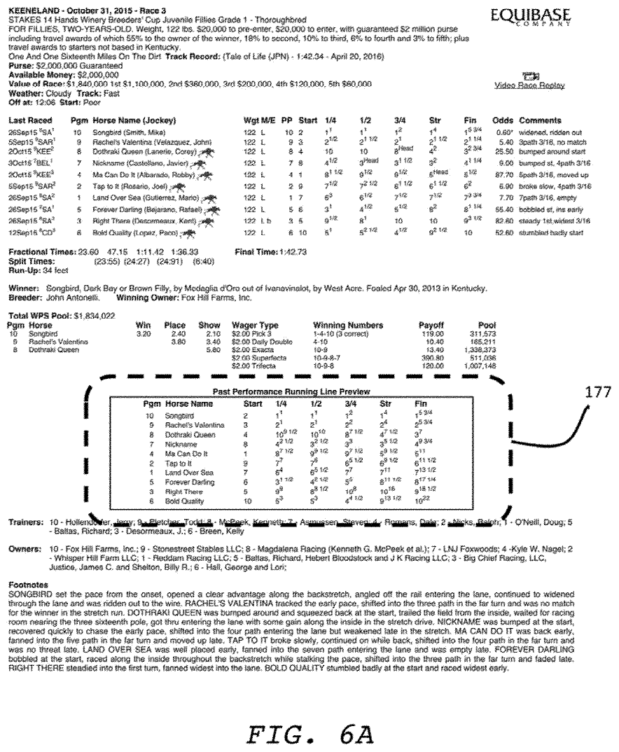

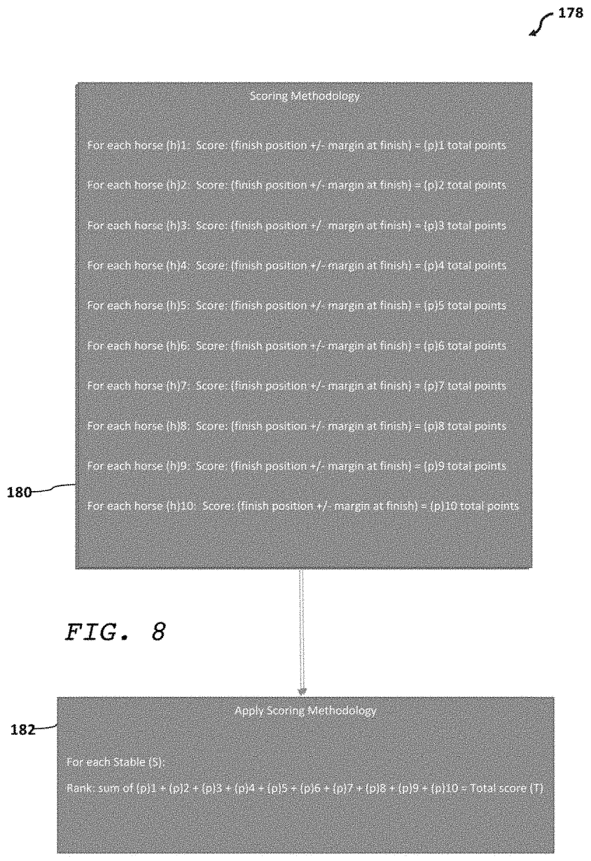

FIG. 8 depicts and illustrates potential application of a scoring methodology 178 consistent with the teachings of the present disclosure. In scoring methodology 178, point calculation step 180 derives total points for each horse a participant selects to race in fantasy-styled horse racing game 10. In the present example, ten horses comprise a stable that competes in nine races. Thus, for each horse, the score of (a) finishing position value [ranging from 0 to 60] and (b) margin at finish are calculated for a given horse total point score (h)1 through (h)10. The value for the margin at finish ranges from 0 to the number of lengths and portions of lengths (1/4, 1/2, 3/4) by which the winning horse leads the other racing horses. At step 182, scoring methodology 178 calculates a rank as a sum of the individual horse values (h)1 through (h)10 to achieve a final sum total score (T).

As an example of the game, consider that when a participant plays fantasy-styled horse racing game 10, his stable comprises ten horses, i.e., one stable per participant and, here, ten horses in the one stable. With nine races in an event, fantasy-styled horse racing game 10 calculates ten final sum total scores; one for each of the ten racing horses in the participant's stable.

In understanding the scoring methodology of FIG. 8, consider the example of an event having nine races. For every race, the present method and system receive from Equibase all of the statistics of the race. Fantasy-styled horse racing game 10 processes the received information and performs the calculations, as shown in FIG. 8. The system and method derive this information for each horse. Such as, for example, if a horse won a race by five lengths, the horse receives 60 points for winning the race and 5 more points for winning by five lengths, for a total of 65 points. Fantasy-styled horse racing game 10 performs these operations internally, so that the participant receives only the results that the game calculates.

In addition to performing the scoring methodology of FIG. 8, however, fantasy-styled horse racing game 10 further compiles a leader board that shows how each of the participating stables have fared against each other.

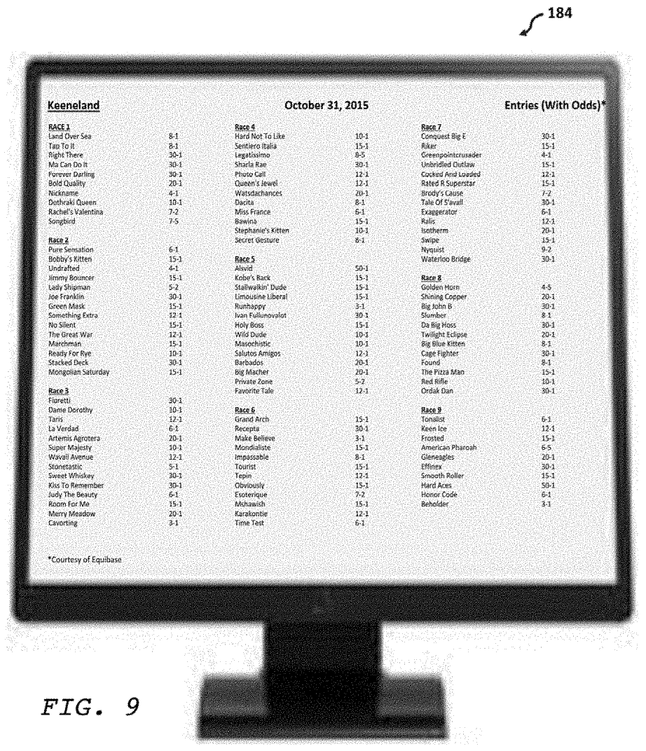

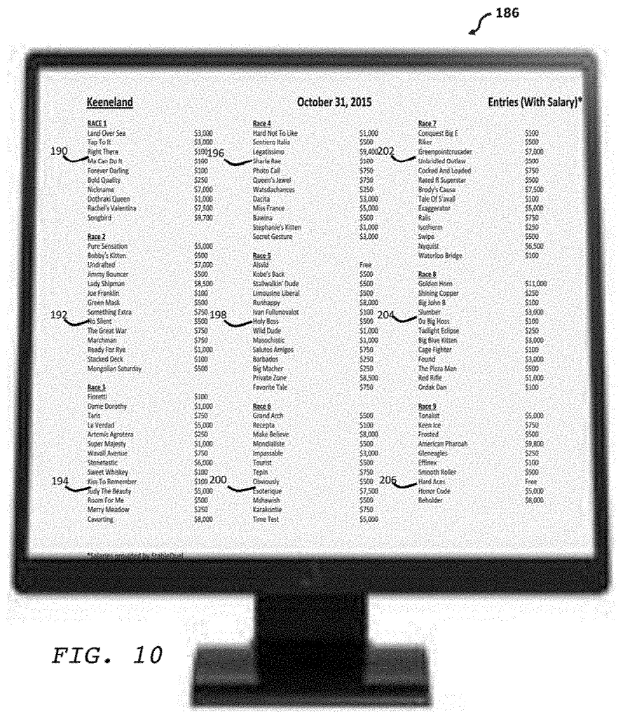

FIG. 9 shows odds for horses scheduled to run on a particular race day for showing an illustrative embodiment of the present disclosure. For example, the example of Keeneland Thoroughbred race track here provides the entries for a given event. FIG. 10, then, shows the results of converting the odds of FIG. 9 to salaries according to the rules appearing in FIG. 7, above. Moreover, FIG. 10 associates salaries with each horse in race 1 190 through race 9 206. These race salary determinations determine values associated with stable formation as demonstrated at FIGS. 11 through 20, below.

FIGS. 11 through 20 present an exemplary stable selection process incorporating the processes, odds, and salaries of FIGS. 7 through 10. Beginning with FIG. 11, the stable selection process starts with a blank stable template 188. In blank stable template 188, the participant receives a salary remaining value of $50,000. It is from this salary resource that the participant may assign horses to the stable. Once a race horse has been selected for a particular race, the salary for the particular horse deducts from the $50,000 total.

At FIG. 12 appears the stable information from the stable selection process after race 1 wherein stable template 190 shows entries for race 1, as depicted originally in FIG. 10. For race 1, FIG. 12 demonstrates the horse, Songbird, with a salary of $9,700 is selected and then goes to a stable position. The participant then has the $9,700 amount deducted from his salary remaining sum, leaving a $40,300 salary remaining.

At FIG. 13 appears the stable information from the stable selection process after race 2 wherein stable template 192 shows entries for race 2, as depicted originally in FIG. 10. Thus, for race 2, FIG. 13 demonstrates that no selection was made to keep the $40,300 salary remaining.

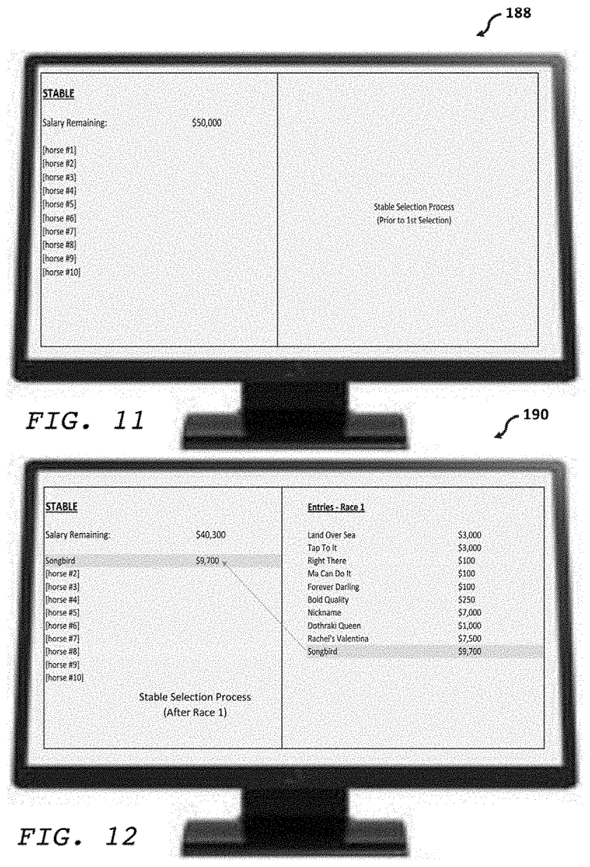

At FIG. 14 appears the stable information from the stable selection process after race 3 wherein stable template 194 shows entries for race 3, as depicted originally in FIG. 10. Thus, for race 3, FIG. 14 demonstrates the horse, Cavorting, with a salary of $8,000 is selected and then goes to a stable position. The participant then has the $8,000 amount deducted from his salary remaining sum, leaving a $32,300 salary remaining.

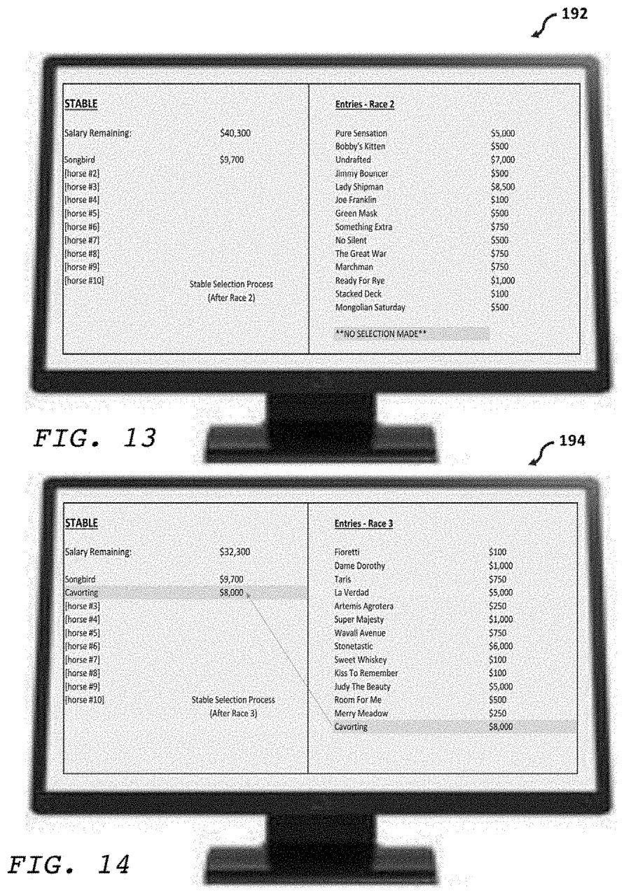

At FIG. 15 appears the stable information from the stable selection process after race 4 wherein stable template 196 shows entries for race 4, as depicted originally in FIG. 10. Thus, for race 4, FIG. 15 demonstrates the horses, Legatissimo at $9,400 and Dacita at $3,000 are selected for stable positions. The participant then has the $12,400 amount deducted from his salary remaining sum, leaving a $19,900 salary remaining.

At FIG. 16 appears the stable information from the stable selection process after race 5 wherein stable template 198 shows entries for race 5, as depicted originally in FIG. 10. Thus, for race 5, FIG. 16 demonstrates the horse; Kobe's back, with a salary of $500 is selected and then goes to a stable position. The participant then has the $500 amount deducted from his salary remaining sum, leaving a $19,400 salary remaining.

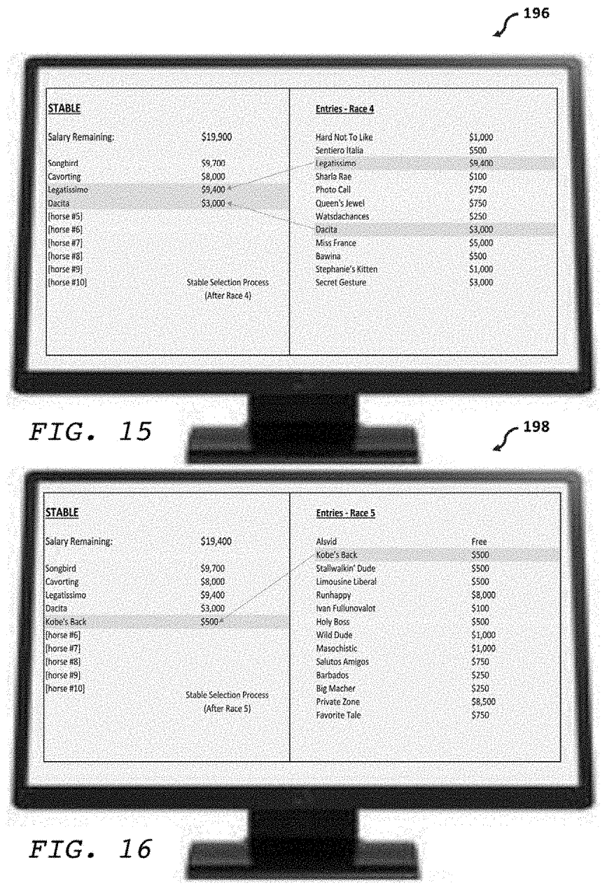

At FIG. 17 appears the stable information from the stable selection process after race 6 wherein stable template 200 shows entries for race 6, as depicted originally in FIG. 10. Thus, for race 6, FIG. 17 demonstrates the horses, Grand Arch at $500 and Tepin at $750 are selected for stable positions. The participant then has the $1,250 amount deducted from his salary remaining sum, leaving a $18,150 salary remaining.

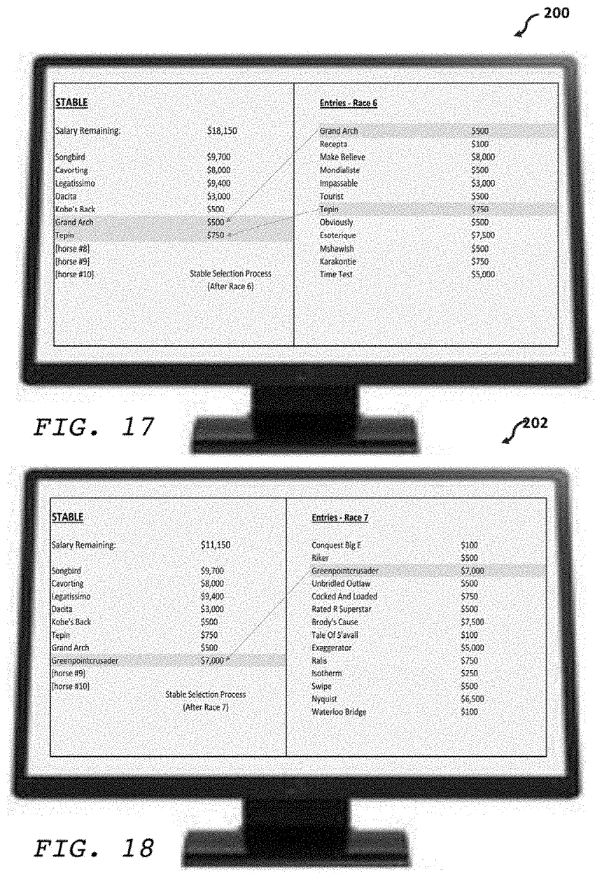

At FIG. 18 appears the stable information from the stable selection process after race 7 wherein stable template 202 shows entries for race 7, as depicted originally in FIG. 10. Thus, for race 7, FIG. 18 demonstrates the horse, Greenpointcrusader, with a salary of $7,000 is selected and then goes to a stable position. The participant then has the $7,000 amount deducted from his salary remaining sum, leaving an $11,150 salary remaining.

At FIG. 19 appears the stable information from the stable selection process after race 8 wherein stable template 204 shows entries for race 8, as depicted originally in FIG. 10. Thus, for race 8, FIG. 19 demonstrates the horse, The Pizza Man, with a salary of $500 is selected and then goes to a stable position. The participant then has the $500 amount deducted from his salary remaining sum, leaving a $10,650 salary remaining.

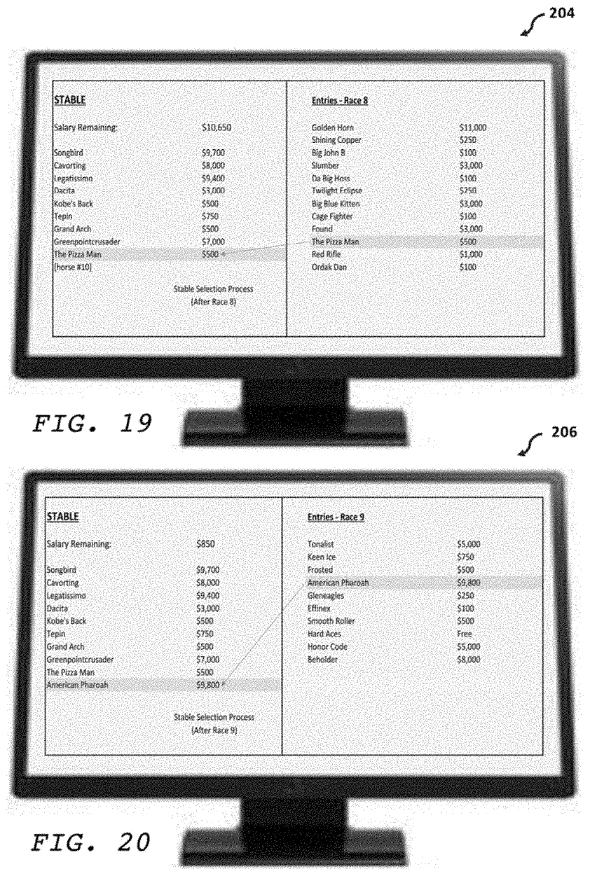

At FIG. 20 appears the stable information from the stable selection process after race 9 wherein stable template 206 shows entries for race 9, as depicted originally in FIG. 10. Thus, for race 9, FIG. 20 demonstrates the horse, American Pharoah, with a salary of $9,800 is selected and then goes to a stable position. The participant then has the $9,800 amount deducted from his salary remaining sum, leaving an $850 salary remaining.

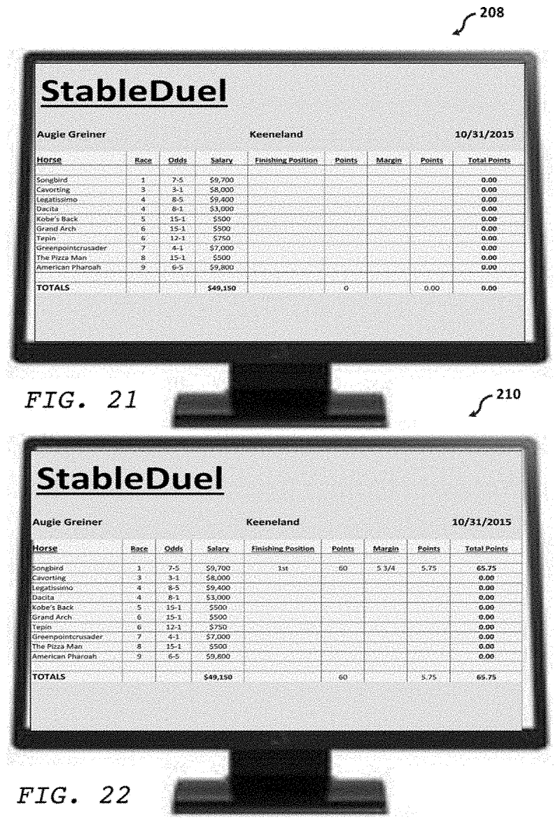

FIGS. 21 through 30 depict an exemplary application of the present disclosure to illustrate how fantasy-style horse racing game 10 compiles scores. Thus, once a participant selects a stable, as FIGS. 11 through 20 show, for example, scoring occurs during an event. The illustrative example of FIGS. 21 through 30 show how scoring include points for finishing positions and relative position at the conclusion of each race of the event. So, using charts from Equibase, fantasy-style horse racing game 10 extracts the information about the races and uses the extracted information for determining point scores for all horses participating in the event.

FIGS. 21 through 30 demonstrate how one may play the fantasy-styled horse racing game 10 of the present disclosure, using an example of the Breeders Cup championship that was held in 2015. The illustrative example of FIGS. 21 through 30 shows how a participant, “Augie Greiner,” may have selected a stable for a racing event and shows the progressive results of the selected stable throughout a racing event. FIG. 21 displays that no points have yet been awarded for a stable that includes Songbird (7-5 odds and $9,700 salary); Cavorting (3-1 odds and $8,000 salary); Legatissimo (8-5 odds and $9,400 salary); Dacita (8-1 odds and $3,000 salary); Kobe's Back (15-1 odds and $500 salary); Grand Arch (15-1 odds and $500 salary); Tepin (12-1 odds and $750 salary); Greenpointcrusader (4-1 odds and $7,000 salary); The Pizza Man (15-1 odds and $500 salary); and American Pharaoh (7-5 odds and $9,700 salary).

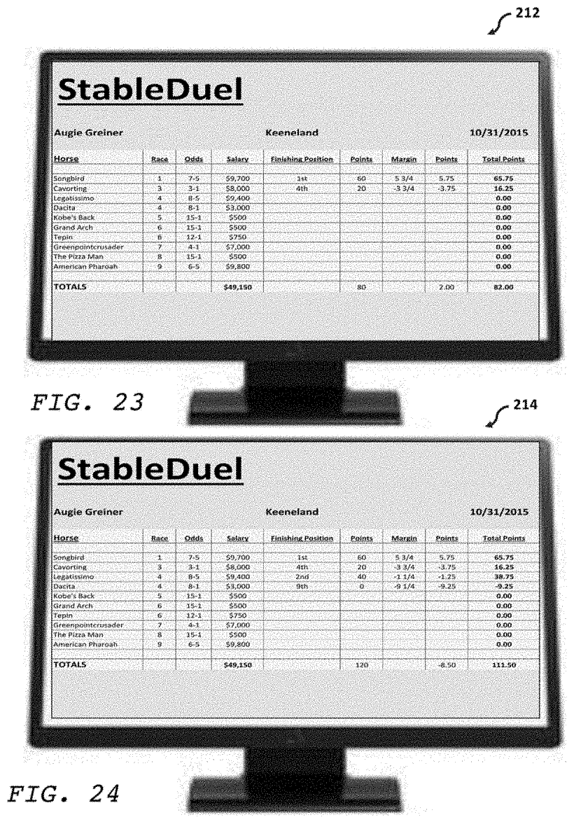

FIG. 22 then shows that Songbird has received 65.75 points upon finishing in 1st place in race 1 and winning by 5 3/4 lengths. Greiner's stable has no horse in race 2. FIG. 23 further shows that Cavorting placed 4th in race 3, and was 3 3/4 lengths behind the winner, causing a negative 3.75 points deducted from the 20 point 4th place value. This gives Cavorting a 16.25 point value. The total for participant Augie Greiner's stable then becomes 82 points.

FIG. 24, depicts the results of race 4, wherein the stable includes 2nd place horse trailing by 1 1/4 lengths, Legatissimo, and 9th place horse trailing by 9 1/4 lengths, Dacita. Here, Legatissimo receives 38.75 points (40 minus 1.25 points) and Dacita receives −9.25 points (0 minus 9.25 points). Note, that now the stable has a 111.50 point total.

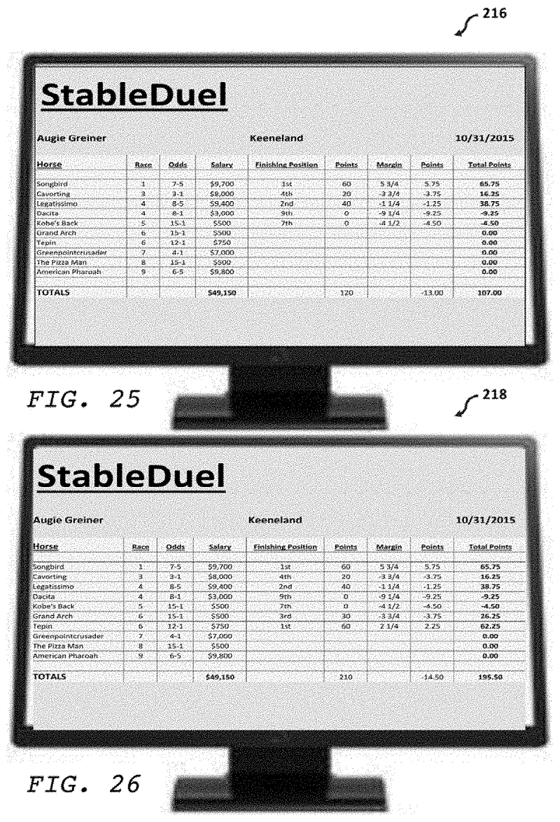

FIG. 25 sets forth that, after race 5, Greiner's stable includes 7th placing horse Kobe's Back, at 4.5 lengths back. This gives a total of 0 points for the placing and minus 4.50 points for being 4.50 lengths behind. Now, the stable value has lost 4.50 points for a total of 107 points.

FIG. 26 shows the results after race 6, where Grand Arch places 3rd at 3 3/4 lengths behind, resulting in a point total of 26.25 (30 minus 3.75), and Tepin wins 1st place, at 2 1/4 lengths ahead for a score of 62.25 (60 plus 2.25) points. Now, Greiner's stable point totals 195.50.

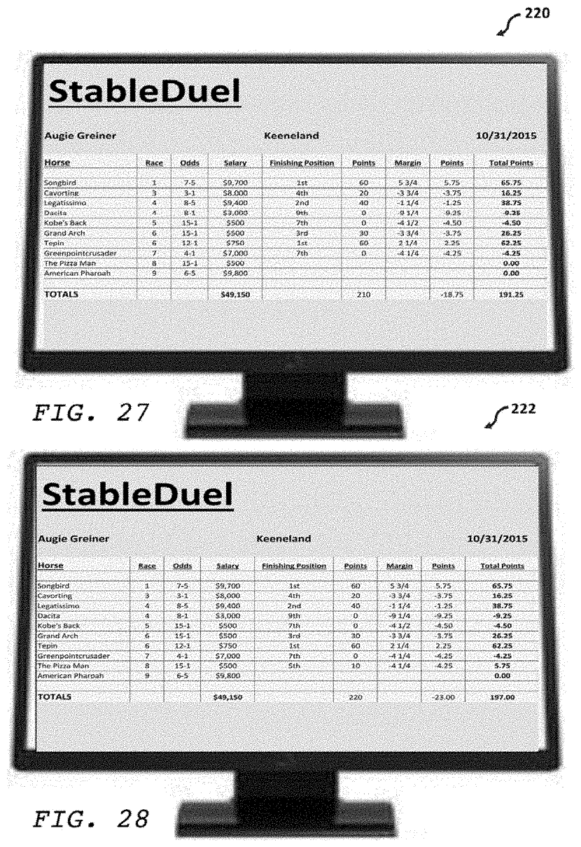

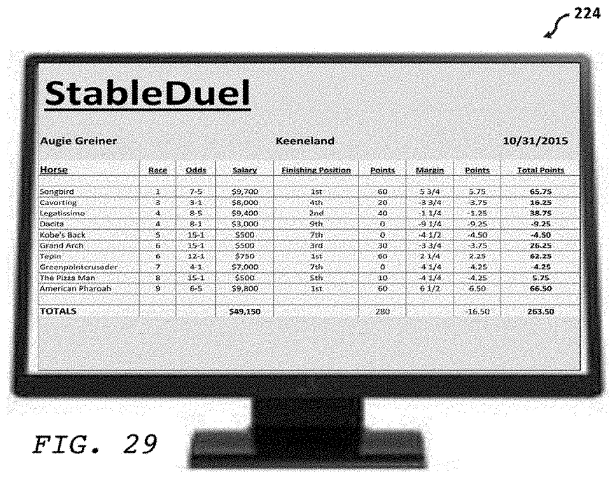

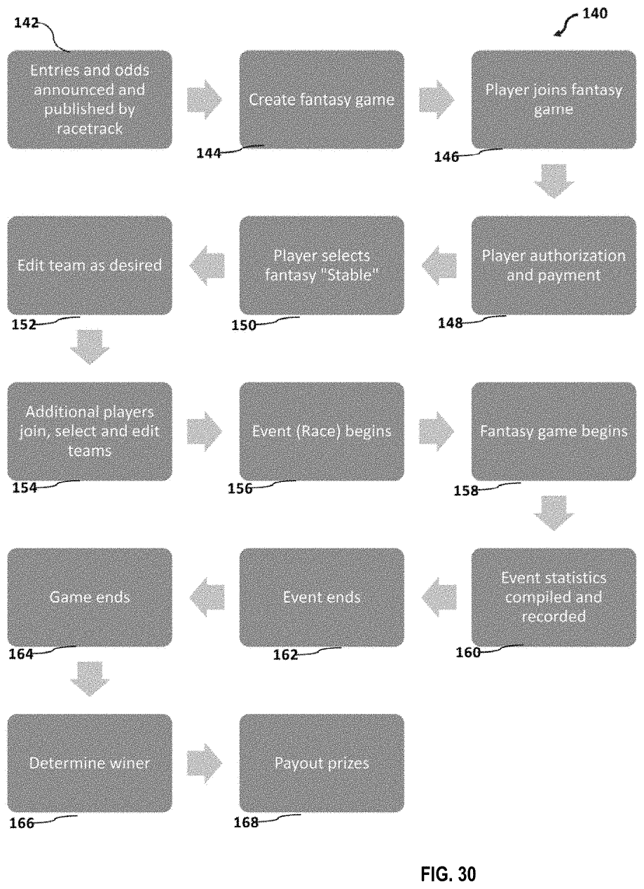

In race 7, Greenpointcrusader places 7th at 41/4 lengths behind, resulting in 4.25 being subtracted from stable total, leaving a 191.25 total, as FIG. 27 shows. In race 8, The Pizza Man places 5th to earn 10 points at 4.25 lengths behind for a total of 5.75 points. Here, FIG. 28, shows a total of 197 points.

Finally, FIG. 29 shows that in race 9 American Pharaoh wins by 6 1/2 lengths. This totals 66.50 points adding to the stable total, for an event total of 263.50 points. For determining the winner of the day's event, Greiner's 263.50 stable total will be compared to that of other participants. The highest point total will win for the day.

The method and system of the present disclosure incorporate a number of rules according to the racing format and other aspects of the associated racing event. For example, in addition to the above exemplary illustrations of operating fantasy-style horse racing game 10, the present disclosure contemplates utilizing several “rules” specific to said game operation. The rules described in the following paragraphs are exemplary of those that will be utilized within the game operation. The game operation will not be limited to these rules, as others not listed here, may also be required.

“Multiple Horse Entries”. Periodically during a racing event (e.g., the actual horse race), the issue of an “Entry” will arise. An “Entry” occurs when an owner has more than one horse entered into a given race. In this instance, instead of each horse being a separate virtual interest, the horses are coupled together to form ONE betting interest. Entries can include two, three, and sometimes four horses. For game purposes, scoring will be calculated based upon current pari-mutuel guidelines regarding this situation. These guidelines stipulate that the horse from the “Entry” that finishes in the best position will be the one used for scoring calculations. An example of a multiple horse entry situation includes a two (2) horse entry, with horses finishing 1st and 5th respectively. Here, scoring would be based on the 1st place finisher, not the 1st and 5th place finishes. All other horses in the race will not be affected by the position of the entry horses as far as finishing position and margin of defeat are concerned. Using the same example from above, if a horse finished 6th (one position behind the second horse in the entry) scoring would still be based on a 6th place finish and the margin of defeat would remain the same.

“Scratched Horses”. In the event of a scratch, i.e., a selected horse is removed from the actual race, the participant will be notified immediately and will be given the opportunity to make a replacement selection. The replacement selection does not need to come from the same race as the scratched horse, but it must come from either that race or a following race. The replacement selection must be made prior to the replacement horse running, not retroactively. The replacement selection must still allow the stable to remain under the salary cap limit established for that contest. If no replacement is selected for the scratched horse, the participant will be awarded a score of “0” points for that horse.

“Disqualifications”. In the event there is a disqualification, scoring will be recalculated based on the following guidelines. The disqualified horse will be scored based upon its subsequent finishing position as determined by the track stewards. For example: if a horse finishes 1st but is disqualified to 3rd, the horse will receive points for a 3rd place finish (30 points) and the margin of defeat will be equivalent to that of the horse it was placed behind. So, using the example from above, if the horse who “originally” finished 3rd was beaten by 5 lengths then the disqualified horse (who now is credited with a 3rd place finish) will also be determined to have been beaten by 5 lengths, and therefore would have 5 points deducted from its score.

Within the disclosed subject matter a variety of differing contests are available. For example, in addition to the standard “StableDuel” game which has been utilized for example purposes throughout this document, players may also select games that differ as to stable size (number of horses required to fill out a stable) and salary cap limits. Contests will also be available that consist of multiple tracks being utilized, as well as contests that span more than one day. Examples of these contests include, but are not limited to, the following:

A StableDuel Multi game would provide that the participant select a “Stable” of ten (10) horses and provides a “Salary Cap” of $50,000. Horses may be selected from the race card at multiple tracks on a certain day.

A MiniDuel game would provide that the participant select a “Stable” of five (5) horses and provides a “Salary Cap” of $25,000. Horses must be selected from the race card at a single track on a certain day.

A MiniDuel Multi game may provide that the participant select a “Stable” of five (5) horses and provides a “Salary Cap” of $25,000. Horses may be selected from the race cards at multiple tracks on a certain day.

A LongshotDuel game would provide that the participant to select a “Stable” of ten (10) horses and provides a “Salary Cap” of $10,000. Horses must be selected from the race card at a single track on a certain day.

A LongshotDuel Multi game would provide that the participant select a “Stable” of ten (10) horses and provides a “Salary Cap” of $10,000. Horses may be selected from the race cards at multiple tracks on a certain day.

A MegaDuel game would provide that the participant select a “Stable” of twenty five (25) horses and provides a “Salary Cap” of $100,000. Horses must be selected from the race card at a single track on a certain day.

Furthermore, the MegaDuel Multi game would provide that the participant select a “Stable” of twenty five (25) horses and provides a “Salary Cap” of $100,000. Horses may be selected from the race cards at multiple tracks on a certain day.

In addition to the various contests available, a variety of contest “types” also fall within the scope of the present disclosure. For instance, a Maiden contest would be for participants who have never won a game on StableDuel. These will be contests primarily made up of participants who are new to playing StableDuel or have a limited experience playing. These contests give the participant a much better chance to win as they do not allow the more experienced participants to compete.

An Allowance contest could be a step up from the “Maiden” ranks. These contests are for participants who meet certain conditions that restrict who may compete. An example may be a contest that is restricted to participants who, at best, have only won once in their lifetime. Or a contest for participants who have not won a contest in the past year. Or a contest for participants who have not won a certain amount of money playing StableDuel.

A Stakes contest could be a step up from the “Allowance” ranks. These contests are for participants who may no longer compete in the Maiden or Allowance contests. These contests usually consist of higher entry fees and larger prize pools. These contests are open to anyone; however, the competition will be much tougher.

A Grade III Stakes contest could be a step up from the “Stakes” ranks. These contests are also for participants who may no longer compete in the Maiden and Allowance contests. These contests will usually consist of higher entry fees and larger prize pools than even the Stakes contests. These contests are also open to everyone; however, the competition will be even tougher than the Stakes competition. These contests will mainly consist of the better handicappers.

A Grade II Stakes contest could be a step up from the Grade III Stakes ranks. These contests are also for participants who may no longer compete in the Maiden and Allowance contests. These contests will usually consist of higher entry fees and even larger prize pools than the Grade III contests. These contests are open to everyone; however, the competition gets even tougher. These contests will mainly consist of the better handicappers.

And, a Grade I Stakes contest could be the best of the best. These will be the top end of the contests. They will be open to everyone, however, they will usually consist of higher entry fees (some greater than $1,000) and will mainly consist of the best handicappers. These contests will usually offer the largest prize pools available, some even reaching $1,000,000 or more.

For the purposes of this disclosure, the terms “individual” and “participant” may be synonymous.

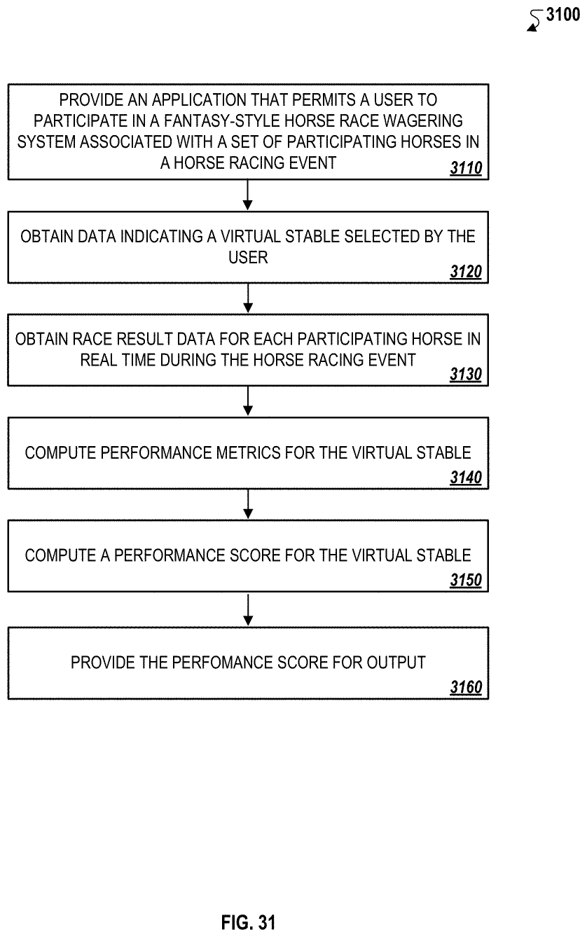

FIG. 31 illustrates an example of a process 3100 for providing an application that enables fantasy-style horse race betting over a network interface. Briefly, the process 3100 includes the operations of providing an application that permits a user to participate in fantasy-style horse race wagering system associated with a set of participating horses in a horse racing event (3110), obtaining data indicating a virtual stable selected by the user (3120), obtaining race result data in real time during the horse racing event (3130), computing performance metrics for the virtual stable (3140), computing a performance score for the virtual stable (3150), and providing the performance score for output through the application (3160).

In general, the process 3100 can be performed by a computing system that includes one or more servers configured to provide an a software application. The application can be executed on computing devices of users that participate in fantasy-style horse race wagering system over a network interface though the application. As described throughout, this configuration allows users to remotely participate in a wagering contest through a computerized interface in a way that maintains the integrity of the contest.

In more detail, the process 3100 can include the operation of providing an application that permits a user to participate in fantasy-style horse race wagering system associated with a set of participating horses in a horse racing event (3110). For example, a server can provide an application over a network interface. As discussed above, the application can be configured to permit a user to participate in fantasy-style horse race wagering system associated with a set of participating horses in a horse racing event. The application restricts the user from participating in the fantasy-style horse race wagering system after the horse racing event has started;

The process 3100 can include the operation of obtaining data indicating a particular stable selected by the user (3120). For example, the server can obtain the data from a computing device of the user over the network interface. The obtained data includes a subset of participating horses that were selected by the user from among the set of participating horses. The obtained data also includes an aggregate salary cap value of the particular stable. As discussed above, the aggregate salary cap value of the particular stable is determined based on pre-race salary value for each participating horse included in the set of participating horses.

The process 3100 can include the operation of obtaining race result data for each participating horse in real time during the horse racing event (3130). For example, the server can access a database of a computing system associated with the horse racing event. The horse race data can specify the races that have taken place during the horse racing event, the winning horse, and statistics associated with the races that have occurred (e.g., a number of lengths between horses that complete a particular race).

The process 3100 can include the operation of computing performance metrics for the particular stable (3140). For example, the server can compute the performance metrics based on the race result data for the participating horses in the horse racing event. As discussed above, the performance metrics can include, without limitation, a horse's place within a race, a number of lengths between sequential places within the race, a horse's time of completion, biometric information for a horse, among others.

The process 3100 can include the operation of computing a performance score for the particular stable (3150). For example, the server can compute a performance score for the particular stable based on the race result data for the set of participating horses and the performance metrics computed for the subset of participating horses that are included in the particular stable. In some implementations, the performance score is computed based on aggregating a set of horse performance scores that are competed for each participating horse included in the subset of participating horses. The horse performance score can represent a performance of a participating horse in the horse racing event. The value associated with the horse performance score can be used to indicate how well the horse performed in a horse race. For example, a horse that won a given race can have a higher value horse performance score relative to another horse that lost the race.

The process 3100 can include the operation of providing the performance score for output through the application (3150). For example, the server can provide the performance score for output through the application. As described above, wagering data collected through the application can be associated with a user's account so that historical activity can be monitored and tracked over time. In some implementations, historical wagering data of a user can be tracked using pattern recognition techniques. Recognized patterns can be used to develop learning tools that are used to improve user engagement and interactivity through the application. For example, a user can access a recommendation engine through the application that allows the user to view informational content (e.g., tutorials for wagering techniques) and/or participate in programs that are geared to improve user's wagering performance in subsequent wagering contests.

In some implementations, the server generates data multiple user pools for the fantasy-style horse race wagering system. The multiple user pools are generated based at least on respective skill levels of the set of users associated with the fantasy-style horse race wagering system. Each user pool included within the user pools includes users classified as having a different skill level associated with the fantasy-style horse race wagering system. For example, the user pools can include a handicapped user pool that only includes newly registered users with novice skill levels and an expert user pool that only includes users with professional wagering skills. In this way, users only compete against other users of the same (or similar) skill level.

In some implementations, the user pools can be dynamically generated before a horse racing event so that user pools include both users that opt to participate in the virtual contest (e.g., friends over a social network) as well as other users that are not associated with them but are classified as having a similar skill level. For example, a user pool can include a given subset of users that opt to participate in the same virtual contest since they have known associations over a social network. In this example, the user pool can be open-ended so that it also includes one or more additional users that are not associated with the given subset of users (e.g., they are not known associations over the social network) but are classified as being relevant to the given subset of users. For example, the relevancy classification can be made based on account data of the one or more additional users indicating that they have a similar skill level as the given subset of users.

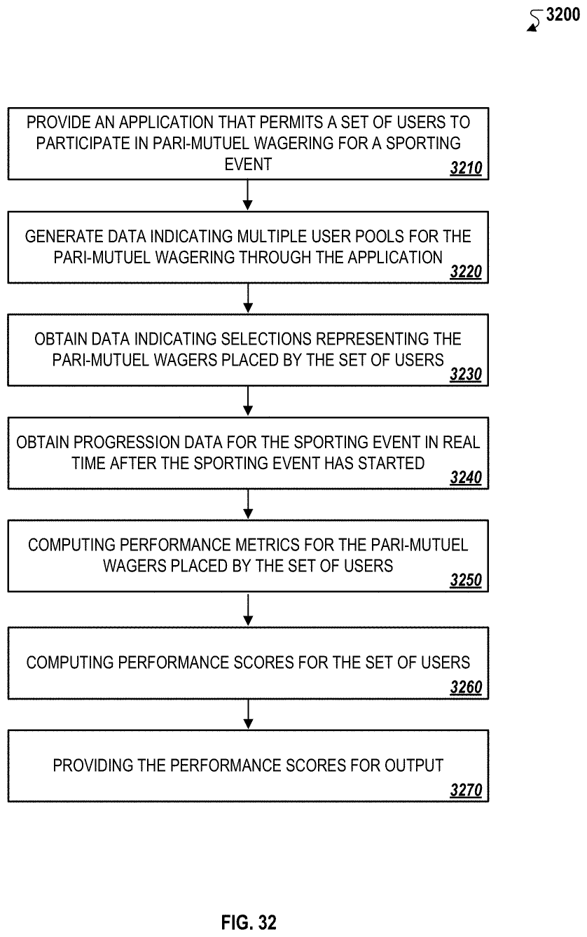

FIG. 32 illustrates an example of a process 3200 for providing an application that enables pari-mutuel betting through a network interface. Briefly, the process 3200 includes the operations of providing an application for placing pari-mutuel bets for a sporting event (3210), generating data indicating multiple user pools for placing the pari-mutuel bets through the application (3220), obtaining sat indicating selections representing the pari-mutuel bets placed by a set of users (3230), obtaining profession data for the sporting event in real event during the sporting event (3240), computing performance metrics for the pari-mutuel bets (3250), computing performance scores for the set of users (3260), and providing the performance scores for output (3270).

In general, the process 3200 can be performed by a computing system that includes one or more servers configured to provide a software application. The application can be executed on computing devices of users that participate in pari-mutuel wagering over a network interface though the application. As described throughout, this configuration allows users to remotely participate in a wagering contest through a computerized interface in a way that maintains the integrity of the contest.

In more detail, the process 3200 can include the operation of providing an application for placing pari-mutuel bets for a sporting event (3210). For example, the server can provide an application over a network interface. The application can be configured to permit a set of users to participate in pari-mutuel wagering for a sporting event (e.g., fantasy-style sports). As described throughout, the application can also be configured to restrict the users from placing the pari-mutuel bets after the sporting event has started. For example, if a pari-mutuel wagering contest relates to a “pick six” horse racing event, then the application requires a user to select all horses before the first horse race begins. In this way, pari-mutuel wagering through the application prevents users from, for instance, waiting until the first race completes to gain an unfair competitive advantage.

In some implementations, the application can be used in gaming scenarios. For instance, the techniques described throughout this specification can be applied in different types of racing, such as harness racing, camel racing, dirt bike racing, among others. The techniques can also be applied to other competitions that don't necessarily involve racing, such as video game contests (e.g., eSports), financial trading platforms, among others.

The process 3200 can include the operation of generating data indicating multiple user pools for placing the pari-mutuel bets through the application (3220). For example, the server generates data indicating multiple user pools for placing the pari-mutuel bets through the application. The multiple user pools are generated based at least on respective skill levels of the set of users associated with pari-mutuel betting. For example, each user pool can have users of similar skill level so that novice users do not place wagers in the same pool as user with more advanced wagering skills. A user's skill level can be determined based on, for instance, account activity (e.g., a number of executed wagers), performance statistics associated with historical wagering activity (e.g., a win/loss ratio), or KYC information associated with an account (e.g., a user identity). Each user pool included within the multiple user pools includes users classified as having a different skill level associated with pari-mutuel betting. For example, the user pools can include a handicapped user pool that only includes newly registered users with novice skill levels and an expert user pool that only includes users with professional wagering skills. In this way, users only compete against other users of the same (or similar) skill level.

The process 3200 can includes the operation of obtaining data indicating selections representing the pari-mutuel wagers placed by a set of users (3230). For example, the server obtains data indicating wagers placed by users in association with the sporting event. The selections can include a particular subset of participating athletes selected by a user from among the set of participating athletes. For example, the selections can include athletes that are predicted to achieve a specified performance level during a sporting event. The selections can also include an aggregate salary cap value of a particular fantasy group based on the respective pre-event salary values of the particular subset of participating athletes. For example, salary values can be designated to each participating athlete that limits the selections of the participating athletes in a pari-mutuel wager placed by a user.

The type of wager placed by users can vary based on the type of sporting event associated with a wagering competition. As one example, for horse race events, the selections can represent a selection of horses to include in a stable. As another example, for a baseball game, the selections can represent athletes that are predicted to achieve a certain performance statistic (e.g., number of homeruns, number of strikeouts, etc.) during the baseball game. The application can be configured to enable wagers on other types of sporting events, such as professional basketball, professional football, among others.

The process 3200 can include the operation of obtaining progression data for the sporting event in real event during the sporting event (3240). For example, the server obtains progression data that indicates athletics statistics computed during the sports event. In a horse racing event, the progression data can identify winners of races that have been completed associated statistics with each of the participating horses (e.g., a time to complete the race, the number of lengths between each horse, etc.).

The process 3200 can includes the operation of computing performance metrics for the pari-mutuel bets (3250). For example, the server can compute performance metrics for the pari-mutuel wagers placed by the set of users based on the progression data obtained in step 3240. The performance metrics can be computed for each of the multiple user pools so that wagers within a single user pool can be tracked relative to one another. In the horse racing example, the performance metrics can include a race position of a participating horse that was selected in a user's stable, a time to complete a race, among other types of statistical information that is collected during a horse race. In other types of sport events, the performance metrics can include athletic statistics for athletes, as well as team statistics for teams that compete against one another during the sport event.

The process 3200 can includes the operation of computing performance scores for the set of users (3260). For example, the server can a performance score for each user included in the set of users. The performance score can be computed based on the selections representing the pari-mutuel bets placed by the set of users, performance metrics for the pari-mutuel bets placed by the set of users, and a user pool to which a user is classified. In a horse racing example, the server computes a performance score for the particular stable based on race result data for the set of participating horses and the performance metrics computed for the subset of participating horses that are included in the particular stable. In some implementations, the performance score is computed based on aggregating a set of horse performance scores that are competed for each participating horse included in the subset of participating horses. The horse performance score can represent a performance of a participating horse in the horse racing event. The value associated with the horse performance score can be used to indicate how well the horse performed in a horse race. For example, a horse that won a given race can have a higher value horse performance score relative to another horse that lost the race.

The process 3200 can includes the operation of providing the performance scores for output (3270). For example, the server can provide the performance score for output through the application. As described above, wagering data collected through the application can be associated with a user's account so that historical activity can be monitored and tracked over time. In some implementations, historical wagering data of a user can be tracked using pattern recognition techniques. Recognized patterns can be used to develop learning tools that are used to improve user engagement and interactivity through the application. For example, a user can access a recommendation engine through the application that allows the user to view informational content (e.g., tutorials for wagering techniques) and/or participate in programs that are geared to improve user's wagering performance in subsequent wagering contests.

In some implementations, the sporting event is associated with a set of participating athletes of a sporting event. For instance, in a wagering contest involving a professional basketball game, the set of participating athletes include basketball players that participate in the basketball game. In such implementations, the process 3200 includes a set of additional operations. For example, the server can obtain pre-event statistics associated with the sporting event (e.g., a player's individual season statistics prior to a present game involved in a wagering contest). The process 3200 also includes generating rule data for the pari-mutuel wagers based on the pre-event statistics. For example, the rule data can specify a fantasy-style contest structure, which includes a respective pre-event salary value for each participating athlete included in the set of participating athletes based on pre-event statistics associated with the sporting event. The rule data can also specify a number of athletes for selection by a user to include in a fantasy group and a maximum salary cap value for the fantasy group.

The application can be configured to provide various types of additional features in association with pari-mutuel wagering. For instance, the application can be configured with assurance measures to combat undesirable behavior during pari-mutuel wagering contests. For example, the server can use pattern recognition techniques to identify user activity patterns that represent undesirable or illicit behaviors (e.g., wagers placed based on insider information, activity that violates applicable gambling regulations, etc.). The server can also use and/or apply learning-based techniques (e.g., machine learning, artificial intelligence) to identify such user activity patterns based on training data of known examples of illicit user activity patterns through the electronic pari-mutuel wagering system. For example, historical wagering activity can be evaluated to predict a likelihood that a user has been attempting to use fraudulent techniques to place wagers that provide unfair competitive advantages relative to other users in the same user pool.

In some implementations, the server can be configured as a content distribution system that provides users with access to content associated with wagering activity performed through the application. For example, the server can determine relevant content to display to users through the application (e.g., displaying advertisements to users at specified time points of a game based on tracking virtual activity). As another example, the system can provide sponsored content through the application during sponsored contests (i.e., contests that are funded by a sponsor, such as a corporate entity).

In some implementations, the system can be configured to use cryptocurrencies and/or tokenized funds in transaction settlement and prize distribution of a wagering content. For example, the application can accept deposits and/or withdrawals of cryptocurrencies (e.g., Bitcoin, Ethereum, Litecoin, ERC20 tokens) and the system can be configured to distribute prizes to a user's cryptocurrency wallet (e.g., a transaction address) or accept cryptocurrency deposits for entering a contest user pool. As one example, the server can provide a tokenized fund that distributes tokens as prizes for winning contests.

In some implementations, the server can be configured to operate with a blockchain network to track wagering activity of users through the application. For example, the server can store activity data collected through application into individual transaction blocks of a blockchain network to develop an immutable public ledger of contest activity. In this example, a transaction block can specify a timestamp associated with when a user placed a bet to counteract against contest activity that takes place after a race has already started. Timestamp information can then be used to invalidate a wager placed after a designated time point (e.g., the start of the first horse race at a horse racing event).

In some implementations, the server can use one or more rule engines to handle unforeseen circumstances. Rules can be used to specify triggers and/or conditions to automate actions to be performed in response to certain circumstances that satisfy the specified triggers and/or conditions. For example, if a horse race associated with a wagering contest is cancelled, then the server can be configured to refund funds provided by users to enter into a pool for the wagering contest.

In some implementations, the server can also be configured to track biometrics of horses and jockeys. For example, the server can track biometric data collected from horses (e.g., blood doping levels) and jockeys to provide users of an electronic pari-mutuel wagering system with information or recommendations useful to subsequent contest activity.

In some implementations, the server can implement virtual reality and/or augmented reality techniques to provide collaborative wagering environment through the application. For example, the server can use holograms to visually represent a horse race in remote locations (e.g., sporting venues, bars) to provide users with a perception of being located at the racetrack.

The terminology used herein is for the purpose of describing particular embodiments only and is not intended to be limiting. As used herein, the singular forms “a”, “an”, and “the” are intended to include the plural forms as well, unless the context clearly indicates otherwise. It may be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

It will be appreciated that for simplicity and clarity of illustration, where considered appropriate, reference numerals may be repeated among the FIGS. to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The embodiments described above are exemplary and are not to be taken as limiting in any way. They are merely illustrative of the principles of the disclosure. Various changes, modifications and alternatives will be apparent to one skilled in the art. Accordingly, it is intended that the art disclosed shall be limited only to the extent required by the appended claims and the rules and principles of applicable law.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fantasy-style horse race wagering system for enabling a user to field, over a network interface, a virtual stable of at least a first horse appearing in a first race and a second horse appearing in a second race in a schedule of races, the system comprising:
one or more computers; and
at least one non-transitory computer-readable medium storing instructions thereon that, when accessible by the one or more computers, cause the one or more computers to perform operations comprising:
providing, over the network interface, an application that (i) permits a user to participate in the fantasy-style horse race wagering system associated with a set of participating horses in a horse racing event by identifying the user to field the virtual stable, and (ii) restricts the user from participating in the fantasy-style horse race wagering system after the horse racing event has started, wherein the fantasy-style horse race wagering system employs a scoring system different from an odds-payoff system associated with a specified race in the schedule of races;
obtaining, from a computing device of the user and over the network interface, data indicating the virtual stable selected by the user;
obtaining race result data for each participating horse included in the set of participating horses in real time during the horse racing event;
computing, based on the race result data, performance metrics for the virtual stable;
computing a performance score for the virtual stable based on the race result data and the performance metrics; and
providing, through the application, the performance score for output.

2. The system of claim 1, wherein:
the operations further comprise generating rule data for the fantasy-style horse race wagering system; and
the rule data specifies:
a pre-race salary value for each participating horse included in the set of participating horses based on pre-event statistics associated with the horse racing event;
a number of horses for selection by a user to include in a stable; and
a maximum salary cap value for the stable.

3. The system of claim 2, wherein the virtual stable comprises (i) a subset of participating horses selected by the user from among the set of participating horses, and (ii) an aggregate salary cap value of the virtual stable based on the pre-race salary values of the subset of participating horses.

4. The system of claim 3, wherein the operations further comprise:
determining whether the aggregate salary cap value of the virtual stable satisfies the maximum salary cap value specified by the rule data; and
determining whether the virtual stable satisfies the rule data based on determining whether the aggregate salary cap value of the virtual stable satisfies the maximum salary cap value specified by the rule data.

5. The system of claim 2, wherein the pre-event statistics comprise respective pre-race odds that each participating horse included in the set of participating horses will win the horse racing event.

6. The system of claim 5, wherein generating the rule data for the fantasy-style horse race wagering system comprises determining the pre-race salary value for each participating horse included in the set of participating horses based on the respective pre-race odds that each participating horse included in the set of participating horses will win the horse racing event.

7. The system of claim 3, wherein computing the performance score for the virtual stable comprises:
computing, for each participating horse included in the subset of participating horses, a horse performance score representing a performance of a participating horse in the horse racing event; and
computing the performance score for the virtual stable by combining the horse performance scores computed for the subset of participating horses.

8. The system of claim 7, wherein:
the race result data indicates a number of lengths between sequential participating horses completing the horse racing event; and
the performance score for the virtual stable is computed based at least on the number of lengths between sequential participating horses completing the horse racing event.

9. The system of claim 1, wherein:
the operations further comprise generating data indicating multiple user pools for the fantasy-style horse race wagering system;
the multiple user pools are generated based at least on respective skill levels of a set of users associated with the fantasy-style horse race wagering system; and
each user pool included within the multiple user pools includes users classified as having a different skill level associated with the fantasy-style horse race wagering system.

10. The system of claim 9, wherein the multiple user pools are generated based on account data indicating an age associated with a user account.

11. The system of claim 9, wherein:
the multiple user pools comprise a first user pool; and
the first user pool comprises (i) a given subset of users that are identified as being associated with social network data and (ii) one or more additional users; and
the one or more additional users are not associated with the social network data and are classified as being relevant to the given subset of users based on account data other than the social network data.

12. A pari-mutuel wagering system for enabling a user to field, over a network interface, a virtual record, the pari-mutuel wagering system comprising:
one or more computers; and
at least one non-transitory computer-readable medium storing instructions thereon that, when accessible by the one or more computers, cause the one or more computers to perform operations comprising:
providing, over the network interface, an application that (i) permits a set of users to participate in the pari-mutuel wagering system for a sporting event and (ii) restricts the users from participating in the pari-mutuel wagering system after the sporting event has started;
generating data indicating multiple user pools for the pari-mutuel wagering system through the application, wherein:
the multiple user pools are generated based at least on respective skill levels of the set of users associated with the pari-mutuel wagering system;
each user pool included within the multiple user pools includes users classified as having a different skill level associated with the pari-mutuel wagering system;
obtaining, from computing devices of the set of users and over the network interface, the virtual record indicating selections representing pari-mutuel wagers placed by the set of users;
obtaining progression data for the sporting event in real time after the sporting event has started;
computing, for each of the multiple user pools and based on the progression data, performance metrics for the pari-mutuel wagers placed by the set of users;
computing, for each user included in the set of users, a performance score based on (i) the virtual record indicating selections representing the pari-mutuel wagers placed by the set of users, (ii) performance metrics for the pari-mutuel wagers placed by the set of users, and (iii) a user pool to which a user is classified; and
providing, through the application, the performance scores computed for the set of users for output.

13. The system of claim 12, wherein:
the sporting event associated with a set of participating athletes of the sporting event;
the operations further comprise:
obtaining pre-event statistics associated with the sporting event, and
generating rule data for the pari-mutuel wagers based on the pre-event statistics; and
the rule data specifies:
a pre-event salary value for each participating athlete included in the set of participating athletes based on pre-event statistics associated with the sporting event,
a number of athletes for selection by a user to include in a fantasy group, and
a maximum salary cap value for the fantasy group.

14. The system of claim 13, wherein:
each selection representing the pari-mutuel wagers placed by the set of users comprises (i) a particular subset of participating athletes selected by a user from among the set of participating athletes, and (ii) an aggregate salary cap value of a particular fantasy group based on the pre-event salary values of the particular subset of participating athletes.

15. The system of claim 14, wherein the operations further comprise:
determining whether the aggregate salary cap value of the particular fantasy group satisfies the maximum salary cap value specified by the rule data; and
determining whether the particular fantasy group satisfies the rule data based on determining whether the aggregate salary cap value of the particular fantasy group satisfies the maximum salary cap value specified by the rule data.

16. A method for enabling a user to field, over a network interface, a virtual stable of at least a first horse appearing in a first race and a second horse appearing in a second race in a schedule of races, the method comprising:
providing, over the network interface, an application that (i) permits a user to participate in a fantasy-style horse race wagering system associated with a set of participating horses in a horse racing event by identifying the user to field the virtual stable of at least the first horse and the second horse, and (ii) restricts the user from participating in the fantasy-style horse race wagering system after the horse racing event has started, wherein the fantasy-style horse race wagering system employs a scoring system different from an odds-payoff system associated with a specified race in the schedule of races;
obtaining, from a computing device of the user and over the network interface, data indicating the virtual stable selected by the user;
obtaining race result data for each participating horse included in the set of participating horses in real time during the horse racing event;
computing, based on the race result data, performance metrics for the virtual stable;
computing a performance score for the virtual stable based on the race result data and the performance metrics; and
providing, through the application, the performance score for output.

17. The method of claim 16, wherein:
the method further comprises generating rule data for the fantasy-style horse race wagering system; and
the rule data specifies:
a pre-race salary value for each participating horse included in the set of participating horses based on pre-event statistics associated with the horse racing event,
a number of horses for selection by a user to include in a stable, and
a maximum salary cap value for the stable;

18. The method of claim 17, wherein the virtual stable comprises (i) a subset of participating horses selected by the user from among the set of participating horses, and (ii) an aggregate salary cap value of the virtual stable based on the pre-race salary values of the subset of participating horses.

19. The method of claim 18, further comprising:
determining whether the aggregate salary cap value of the virtual stable satisfies the maximum salary cap value specified by the rule data; and
determining whether the virtual stable satisfies the rule data based on determining whether the aggregate salary cap value of the virtual stable satisfies the maximum salary cap value specified by the rule data.

20. The system of claim 17, wherein the pre-event statistics comprise respective pre-race odds that each participating horse included in the set of participating horses will win the horse racing event.
